(19) United States
(12) Patent Application Publication
(10) Pub. No.: US 2009/0267984 A1
(43) Pub. Date: Oct. 29, 2009

(54) Liquid Ejection Apparatus and Method for Forming Pattern

(75) Inventors: Tatsuya Nakano, Nagano-ken (JP); Masahiko Yoshida, Shiojiri-shi (JP); Kohei Ueno, Shiojiri-shi (JP); Kazuo Saito, Shiojiri-shi (JP); Takashi Akahane, Nagano-ken (JP)

Correspondence Address: EDWARDS ANGELL PALMER & DODGE LLP, P.O. BOX 55874, BOSTON, MA, 02205, US

(73) Assignee: SEIKO EPSON CORPORATION, Tokyo (JP)

(21) Appl. No.: 12/253,669

(22) Filed: Oct. 17, 2008

(30) Foreign Application Priority Data
Oct. 18, 2007 (JP) 2007-271559

(51) Int. Cl. B41J 29/38

(52) U.S. Cl. 347/16

(57) ABSTRACT

A liquid ejection apparatus includes an ejecting section, an upstream-side transport roller, a downstream-side transport roller, and a control section. The ejecting section ejects liquid onto a medium. The upstream-side transport roller is positioned closer to an upstream side than the ejecting section in a transport direction of the medium, and the downstream-side transport roller is positioned closer to a downstream side than the ejecting section. The upstream-side transport roller and the downstream-side transport roller transport the medium in cooperation with each other by rotating. The control section forms a first pattern by causing the ejecting section to eject the liquid onto the medium in case that an upstream-side end section of the medium in the transport direction is sandwiched with a sandwich section of the upstream-side transport roller. Besides, the control section causes the upstream-side transport roller and the downstream-side transport roller to transport the medium until the upstream-side end section of the medium on which the first pattern is formed becomes positioned closer to the downstream side than the sandwich section in the transport direction and ceases to be sandwiched with the sandwich section, and forms a second pattern by causing the ejecting section to eject the liquid onto the medium the upstream-side end section of which is not sandwiched with the sandwich section.

### CROSS-REFERENCE TO RELATED APPLICATIONS

The present application claims priority from Japanese Patent Application No. 2007-271559 filed on Oct. 18, 2007, which is herein incorporated by reference.

### BACKGROUND

1. Technical Field

The invention relates to a liquid ejection apparatus and a method for forming a pattern.

2. Related Art

As one of liquid ejection apparatuses, there is known an inkjet printer that performs printing by ejecting liquid (ink) onto a medium such as paper, cloth, or film. The printer is provided with an ejecting section that ejects liquid onto a medium, a pair of upstream-side transport rollers located closer to an upstream side than the ejecting section in a transport direction of the medium, and a pair of downstream-side transport rollers located closer to a downstream side than the ejecting section. To transport a medium with two rollers and to eject liquid using the ejecting section are alternately repeated, so that printing is performed. (See JP-A-5-96796).

The above-mentioned two transport rollers rotate having a medium therebetween, so that the rollers cooperate with each other and transport the medium. However, after an end section that is of the medium and close to an upstream side in the transport direction passes a sandwich section of the upstream-side transport rollers, only the downstream-side transport rollers transport the medium. It is known there is different between transporting manner of a medium when the medium is transported with being sandwiched with two sets of the transport rollers, and transporting manner of a medium at a moment when the upstream-side end section ceases to be sandwiched with the sandwich section of the upstream-side transport rollers. Specifically, a transport amount at a moment when the upstream-side end section ceases to be sandwiched with the sandwich section temporarily decreases or increases compared to a transport amount when the medium is transported with being sandwiched with two sets of the transport rollers.

Incidentally, regarding the transporting manner when the medium is transported with being sandwiched with the sandwich section, conventionally the transporting manner was grasped by such a method as forming a pattern on the medium and the correction of transportation error, etc. was properly performed. On the other hand, regarding the transporting manner of the medium at a moment when the medium ceases to be sandwiched with the sandwich section of the upstream-side transport rollers, the transporting manner was not grasped and the correction of transportation error, etc. was not performed properly.

### SUMMARY

An advantage of some aspects of the invention is to sufficiently grasp a transporting manner of a medium at a moment when an upstream-side end section that is of the medium and is close to an upstream side in a transport direction ceases to be sandwiched between the sandwich section of the upstream-side transport roller.

In order to solve the above-mentioned problems, a primary aspect of the invention is a liquid ejection apparatus, including:

(a) an ejecting section that ejects liquid onto a medium;

(b) an upstream-side transport roller that is positioned closer to an upstream side than the ejecting section in a transport direction of the medium, and a downstream-side transport roller that is positioned closer to a downstream side than the ejecting section,
the upstream-side transport roller and the downstream-side transport roller transporting the medium in cooperation with each other by rotating; and

(c) a control section
that forms a first pattern by causing the ejecting section to eject the liquid onto the medium in case that an upstream-side end section of the medium in the transport direction is sandwiched with a sandwich section of the upstream-side transport roller,
that causes the upstream-side transport roller and the downstream-side transport roller to transport the medium until the upstream-side end section of the medium on which the first pattern is formed becomes positioned closer to the downstream side than the sandwich section in the transport direction and ceases to be sandwiched with the sandwich section, and
that forms a second pattern by causing the ejecting section to eject the liquid onto the medium the upstream-side end section of which is not sandwiched with the sandwich section.

Other features of the invention will become clear by the accompanying drawings and the description hereinbelow.

### BRIEF DESCRIPTION OF THE DRAWINGS

FIG. 1 is a block diagram of the overall configuration of a printer 1.

FIG. 2A is a schematic diagram of the overall configuration of the printer 1. FIG. 2B is a cross-sectional view of the overall configuration of the printer 1.

FIG. 3 is an explanatory diagram showing an arrangement of nozzles.

FIG. 4 is an explanatory diagram of a configuration of a transportation unit 20.

FIG. 5 is a graph for illustrating AC component transportation error.

FIG. 6 is a graph (conceptual graph) of a transportation error that is generated when paper is transported.

FIG. 7 is a flowchart showing up to determining the correction values for correcting transport amounts.

FIGS. 8A through 8C are explanatory diagrams of conditions up to determining the correction values.

FIG. 9 is an explanatory diagram illustrating a state of printing a measurement pattern.

FIG. 10A is a vertical sectional view of a scanner 150. FIG. 10B is a top view of the scanner 150 with a lid 151 detached.

FIG. 11 is a graph showing a reading position error of the scanner.

FIG. 12A is an explanatory diagram of a reference sheet SS.

FIG. 12B is an explanatory diagram of condition in which a test sheet TS and a reference sheet SS are set on a document platen grass 152.

FIG. 13 is a flowchart of a correction value calculating process in S103.

FIG. 14 is an explanatory diagram of image division (S131).

FIG. 15A is an explanatory diagram showing how tilt of an image of the measurement pattern is detected. FIG. 15B is a graph of tone values of extracted pixels.

FIG. 16 is an explanatory diagram how tilt during printing of the measurement pattern printing is detected.

FIG. 17 is an explanatory diagram of a white space amount X.

FIG. 18A is an explanatory diagram of image range used in calculating line positions. FIG. 18B is an explanatory diagram of calculating the line positions.

FIG. 19 is an explanatory diagram of calculated line positions.

FIG. 20 is an explanatory diagram of calculating an absolute position of i-th line in the measurement pattern.

FIG. 21 is an explanatory diagram of ranges associated with the correction values C(i) and the like.

FIG. 22 is an explanatory diagram of a relationship between the lines of the measurement pattern and the correction value Ca.

FIG. 23 is an explanatory diagram of ranges associated with correction values Ca(i), Cc, Cb1, and Cb2.

FIG. 24 is an explanatory diagram of a table stored in a memory 63.

FIG. 25 is an explanatory diagram of correction values in a first case.

FIG. 26 is an explanatory diagram of correction values in a second case.

FIG. 27 is an explanatory diagram of correction values in a third case.

FIG. 28 is an explanatory diagram of correction values in a fourth case.

FIGS. 29A through 29C are diagrams for illustrating transport conditions of paper S.

FIGS. 30A through 30C are diagrams for illustrating transportation error when a front end of the paper S becomes in contact with rollers.

FIG. 31 is a diagram showing a test sheet on which a measurement pattern is printed.

### DESCRIPTION OF EXEMPLARY EMBODIMENTS

At least the following matters will be made clear by the present specification and the accompanying drawings.

A liquid ejection apparatus, including: (a) an ejecting section that ejects liquid onto a medium; (b) an upstream-side transport roller that is positioned closer to an upstream side than the ejecting section in a transport direction of the medium, and a downstream-side transport roller that is positioned closer to a downstream side than the ejecting section, the upstream-side transport roller and the downstream-side transport roller transporting the medium in cooperation with each other by rotating; and (c) a control section that forms a first pattern by causing the ejecting section to eject the liquid onto the medium in case that an upstream-side end section of the medium in the transport direction is sandwiched with a sandwich section of the upstream-side transport roller, that causes the upstream-side transport roller and the downstream-side transport roller to transport the medium until the upstream-side end section of the medium on which the first pattern is formed becomes positioned closer to the downstream side than the sandwich section in the transport direction and ceases to be sandwiched with the sandwich section, and that forms a second pattern by causing the ejecting section to eject the liquid onto the medium the upstream-side end section of which is not sandwiched with the sandwich section. With this liquid ejection apparatus, it is possible to sufficiently grasp a transporting manner of the medium at a moment when the medium cease to be sandwiched with the sandwich section of the upstream-side transport roller.

Further, in such a liquid ejection apparatus, it is desirable that the first pattern and the second pattern are a pattern for correcting a transportation error of the medium in case that the medium the upstream-side end section of which is sandwiched with the sandwich section is transported in such a manner as the upstream-side end section is positioned closer to the downstream side than the sandwich section in the transport direction. In such a case, it is possible to properly correct a transport amount at a moment when the medium ceases to be sandwiched with the sandwich section.

Further, in such a liquid ejection apparatus, it is desirable that the first pattern and the second pattern are each a line formed in a direction intersecting the transport direction. In such a case, it is possible to promptly form the first pattern and the second pattern.

Further, in such a liquid ejection apparatus, it is desirable that a transport amount of the medium from formation of the first pattern to formation of the second pattern is less than a transport amount of the medium in case that the upstream-side transport roller performs one rotation. In such a case, it is possible to correct transportation error more properly.

Further, a liquid ejection apparatus, including: (a) an ejecting section that ejects liquid onto a medium; (b) an upstream-side transport roller that is positioned closer to an upstream side than the ejecting section in a transport direction of the medium, and a downstream-side transport roller that is positioned closer to a downstream side than the ejecting section, the upstream-side transport roller and the downstream-side transport roller transporting the medium in cooperation with each other by rotating; and (c) a control section that forms a first pattern by causing the ejecting section to eject the liquid onto the medium in case that a downstream-side end section of the medium in the transport direction is positioned closer to an upstream side in the transport direction than a sandwich section of the downstream-side transport roller and is not sandwiched with the sandwich section, that causes the upstream-side transport roller and the downstream-side transport roller to transport the medium until the downstream-side end section of the medium on which the first pattern is formed starts to be sandwiched with the sandwich section, and that forms a second pattern by causing the ejecting section to eject the liquid onto the medium the downstream-side end section of which is sandwiched with the sandwich section. With this liquid ejection apparatus, it is possible to sufficiently grasp a transporting manner of the medium at a moment when the medium starts to be sandwiched with the sandwich section of the downstream-side transport roller.

Further, a method for forming a pattern, including: forming a first pattern onto a medium that is transported by an upstream-side transport roller and by a downstream-side transport roller in case that a upstream-side end section of the medium in a transport direction is sandwiched with a sandwich section of the upstream-side transport roller; causing the upstream-side transport roller and the downstream-side transport roller to transport the medium until the upstream-side end section of the medium on which the first pattern is formed becomes positioned closer to the downstream side than the sandwich section in the transport direction and ceases to be sandwiched with the sandwich section; and forming a second pattern onto the medium the upstream-side end section of which is not sandwiched with the sandwich section. With this method for forming a pattern, it is possible to sufficiently grasp a transporting manner of the medium at a moment when the medium ceases to be sandwiched with the sandwich section of the upstream-side transport roller.

### Configuration of Printer

### Regarding Configuration of Inkjet Printer

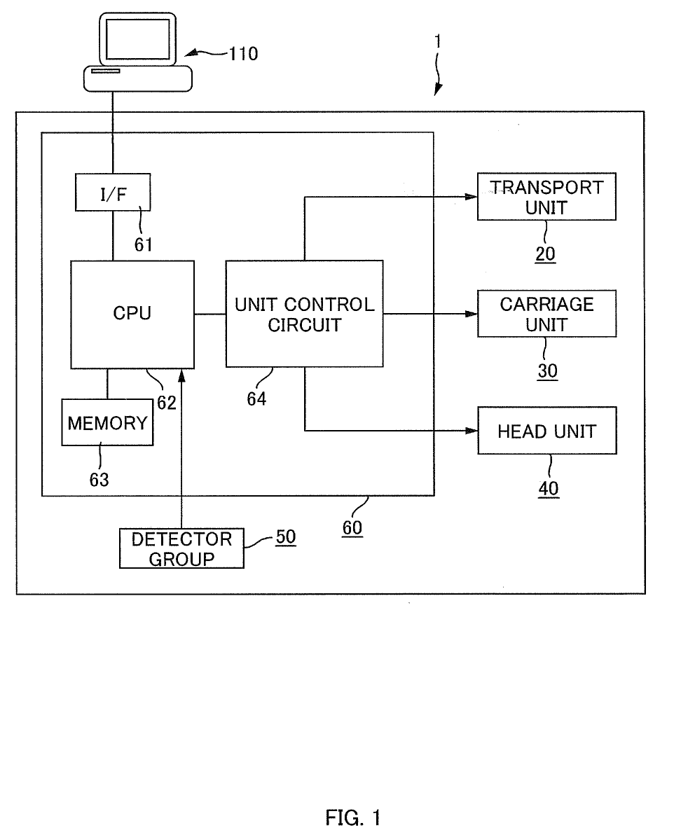

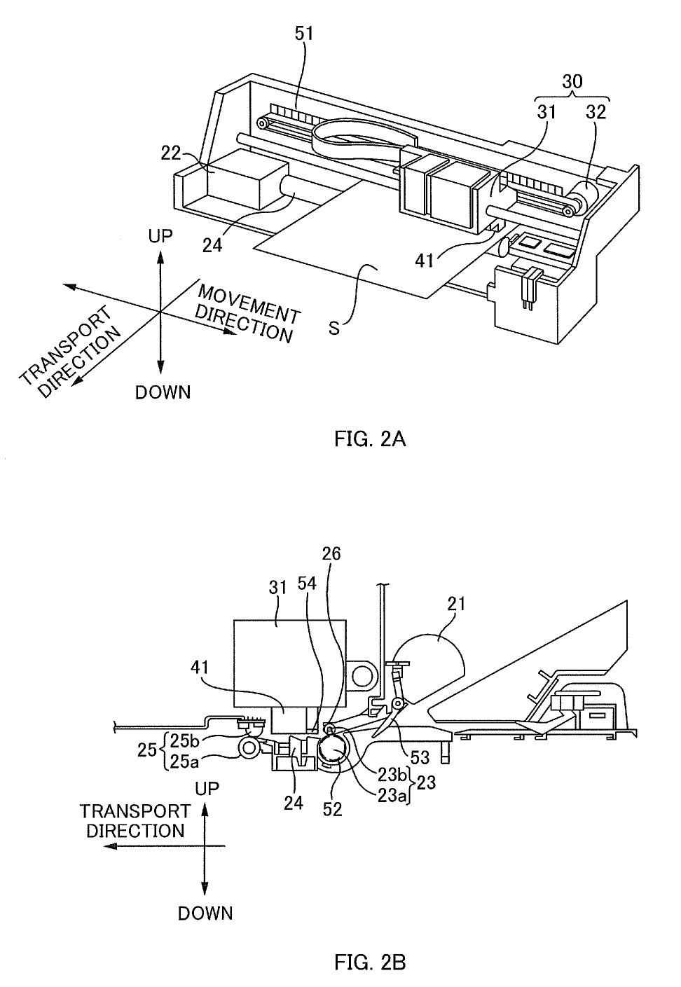

FIG. 1 is a block diagram of the overall configuration of a printer 1 that is one example of a liquid ejection apparatus. FIG. 2A is a schematic diagram of the overall configuration of the printer 1. FIG. 2B is a cross-sectional view of the overall configuration of the printer 1. The basic configuration of a printer is described below.

The printer 1 includes a transportation unit 20, a carriage unit 30, a head unit 40, a detector group 50, and a controller 60. The printer 1 receives print data from a computer 110, which is an external device, and controls various units (the transportation unit 20, the carriage unit 30, and the head unit 40) through the controller 60. The controller 60 controls the various units based on the print data received from the computer 110, and prints an image on paper. The detector group 50 monitors the conditions within the printer 1, and outputs the result of this detection to the controller 60. The controller 60 controls these units based on the detection result received from the detector group 50.

The transportation unit 20 is for transporting a medium (for example, paper S) in a certain direction (hereinafter referred to as a transport direction). The transportation unit 20 has a paper supply roller 21, a transport motor 22 (also referred to as a PF motor), upstream-side transport rollers 23, a platen 24, and downstream-side transport rollers 25. The paper supply roller 21 is a roller for supplying, into the printer, paper that has been inserted into a paper-insert opening. The upstream-side transport rollers 23 are a pair of rollers that transport the paper S supplied by the paper supply roller 21 up to a printable area. The upstream-side transport rollers 23 are constructed of a paper carry roller 23a and a driven roller 23b, and positioned closer to an upstream side than the platen 24 in a transport direction of the paper S. The paper carry roller 23a is driven by the transport motor 22. The platen 24 supports the paper S during printing. The downstream-side transport rollers 25 are a pair of rollers that discharge the paper S out of the printer. The downstream-side transport rollers 25 are constructed of a paper discharge roller 25a and a driven roller 25b, and positioned closer to a downstream side than the platen 24 in the transport direction. The paper discharge roller 25a rotates in synchronization with the paper carry roller 23a.

The carriage unit 30 is for moving (also referred to as “scanning”) a head serving as an example of an ejecting section in a certain direction (hereinafter referred to as a movement direction). The carriage unit 30 has a carriage 31 and a carriage motor 32 (also referred to as a CR motor). The carriage 31 can move back and forth in the movement direction, and is driven by the carriage motor 32. Also, the carriage 31 detachably retains an ink cartridge that contains ink serving as an example of liquid.

The head unit 40 is for ejecting ink onto paper. The head unit 40 has a head 41 including a plurality of nozzles. The head 41 is provided on the carriage 31. Thus, when the carriage 31 moves in the movement direction, the head 41 also moves in the movement direction. The head 41 intermittently ejects ink while moving in the movement direction; as a result thereof, a dot line (raster line) is formed on paper in the movement direction.

The detector group 50 includes a linear encoder 51, a rotary encoder 52, a paper detection sensor 53, an optical sensor 54, and the like. The linear encoder 51 detects a position of the carriage 31 in the movement direction. The rotary encoder 52 detects a rotation amount of the paper carry roller 23a. The paper detection sensor 53 detects a position of a front end of paper that is being supplied. The optical sensor 54 detects the presence and absence of paper with a light-emitting section and a light-receiving section that are mounted to the carriage 31. The optical sensor 54 detects a position of an end of paper while being moved by the carriage 31, and also can detect the width of the paper. In addition, the optical sensor 54 can detects a front end (end on the downstream side in the transport direction; also referred to as an upper end) and a rear end (end on the upstream side in the transport direction; also referred to as a lower end) of paper depending on conditions.

The controller 60 is a control unit (control section) for carrying out control of the printer. The controller 60 includes an interface section 61, a CPU 62, a memory 63, and a unit control circuit 64. The interface section 61 exchanges data between the computer 110, which is an external device, and the printer 1. The CPU 62 is a processing unit for carrying out overall control of the printer. The memory 63 is for ensuring a work area and a storage area for programs of the CPU 62, for instance, and includes storage devices such as a RAM or an EEPROM. The CPU 62 controls the various units via the unit control circuit 64 in accordance with programs stored in the memory 63.

### Regarding Nozzle

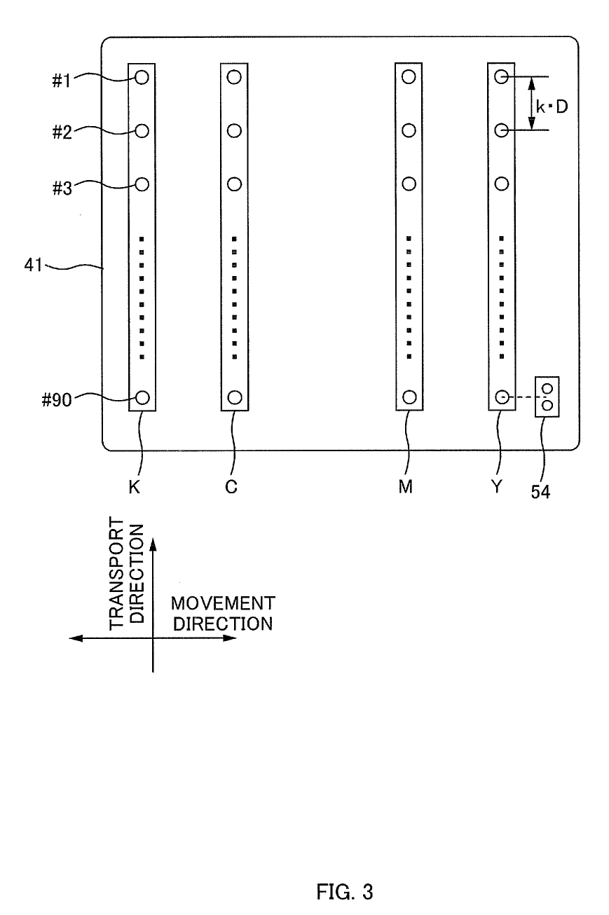

FIG. 3 is an explanatory diagram showing an arrangement of nozzles in a lower surface of the head 41. A black ink nozzle group K, a cyan ink nozzle group C, a magenta ink nozzle group M, and a yellow ink nozzle group Y are formed in the lower surface of the head 41. Each nozzle group has 90 nozzles serving as an ejection opening for ejecting ink of the respective colors.

A plurality of nozzles of each nozzle group are each arranged in rows at a constant spacing (nozzle pitch: k·D) in the transport direction. Here, D is the minimum dot pitch in the transport direction (that is, spacing between dots formed on the paper S at maximum resolution). Further, k is an integer of 1 or more. For example, if the nozzle pitch is 90 dpi ( 1/90 inch) and the dot pitch in the transport direction is 720 dpi ( 1/720 inch), then k=8.

A nozzle of each nozzle group is assigned a number (#1 through #90) that becomes smaller as the nozzle is located more downstream. Specifically, the nozzle #1 is located closer to the downstream side than the nozzle #90 in the transport direction. Note that the above-mentioned optical sensor 54 is located at a substantially same position as the nozzle #90, which is located closest to the upstream side, with respect to a position in the transport direction of paper.

Each nozzle is provided with an ink chamber (not shown) and a piezo element. Driving the piezo element causes the ink chamber to expand and contract; thereby an ink droplet is ejected from the nozzle.

### Regarding Transporting Manner of Paper

The foregoing upstream-side transport rollers 23 and the downstream-side transport rollers 25 transport together the paper S in the transport direction by rotating while the paper S being sandwiched between these sets of the rollers. The transporting manner of the paper S that is transported by two sets of rollers in this manner is described.

The paper supplied in the printer by the paper supply roller 21 initially is sandwiched between the paper carry roller 23a and the driven roller 23b, and transported by the upstream-side transport rollers 23 alone toward the downstream side in the transport direction. When the paper S remains sandwiched between the upstream-side transport rollers 23 and is transported in the transport direction, a front end of the paper S becomes sandwiched between the paper discharge roller 25a and the driven roller 25b. In other words, the paper S is sandwiched between the upstream-side transport rollers 23 and also between the downstream-side transport rollers 25. Thereafter, in cooperation with these sets of the rollers, the paper S is further transported toward the downstream side. The paper S is being transported with being sandwiched between both sets of the rollers; then, a rear end of the paper S comes off the upstream-side transport rollers 23. That is, the paper S becomes sandwiched between only the downstream-side transport rollers 25 of the sets of the rollers. Thereafter, the paper S continues to be transported toward the downstream side by the downstream-side transport rollers 25 alone, and finally is discharged out of the printer.

### Transportation Error

### Regarding Relationship Between Transport Amount of Paper and Rotation Amount of Paper Carry Roller 23a

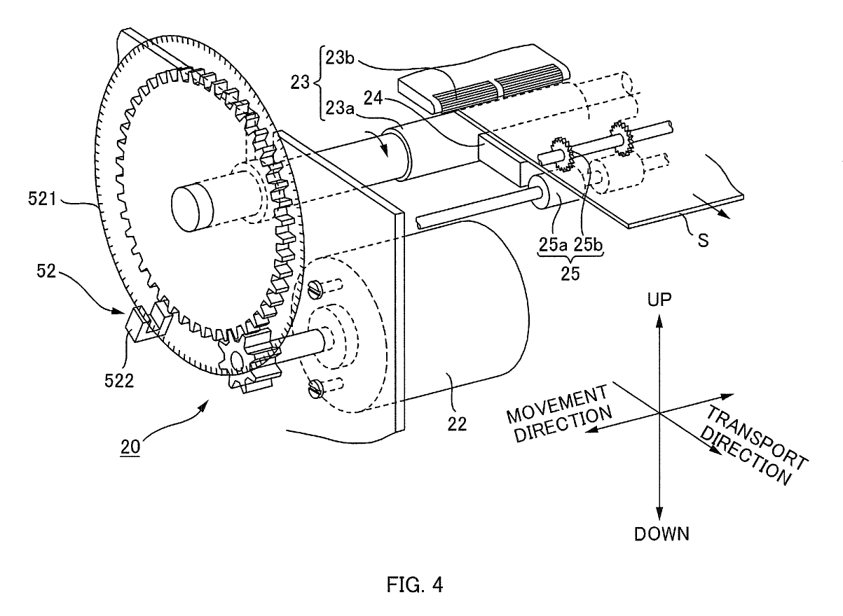

FIG. 4 is an explanatory diagram of a configuration of the transportation unit 20.

Of the upstream-side transport rollers 23 and the downstream-side transport rollers 25, in order to cause at least the upstream-side transport rollers 23 to perform a transport operation, the transportation unit 20 drives the transport motor 22 a certain drive amount according to a transport instruction from the controller 60. The transport motor 22 generates drive force in a rotating direction according to the instructed drive amount. The transport motor 22 rotates the upstream-side transport roller 23 (the paper carry roller 23a) using this drive force. That is, when the transport motor 22 generates a certain drive amount, the paper carry roller 23a rotates a certain rotation amount. When the paper carry roller 23a rotates the certain rotation amount, the paper is transported by a certain transport amount.

The transport amount of paper is determined depending on the rotation amount of the paper carry roller 23a. In this embodiment, when the paper carry roller 23a has performed a full rotation, paper is transported by one inch (that is, the circumference of the paper carry roller 23a is one inch). Thus, when the paper carry roller 23a performs a ¼ rotation, the paper is transported by ¼ inch. Accordingly, if the rotation amount of the paper carry roller 23a can be detected, it is also possible to detect the transport amount of the paper. Therefore, in order to detect the rotation amount of the paper carry roller 23a, the rotary encoder 52 is provided.

The rotary encoder 52 includes a scale 521 and a detection section 522. The scale 521 has a large number of slits provided at a certain spacing. The scale 521 is provided to the paper carry roller 23a. That is, the scale 521 rotates together with the paper carry roller 23a when the paper carry roller 23a rotates. When the paper carry roller 23a rotates, each slit in the scale 521 successively passes through the detection section 522. The detection section 522 is provided opposing the scale 521, and fixed on the main printer unit side. The rotary encoder 52 outputs a pulse signal each time a slit provided in the scale 521 passes through the detection section 522. The slits provided in the scale 521 successively passes through the detection section 522 according to the rotation amount of the paper carry roller 23a. Therefore, the rotation amount of the paper carry roller 23a is detected based on the output of the rotary encoder 52.

When paper is to be transported by a transport amount of one inch for example, the controller 60 drives the transport motor 22 until the rotary encoder 52 detects that the paper carry roller 23a performs a full rotation. As mentioned above, the controller 60 drives the transport motor 22 until a rotation amount corresponding to a targeted transport amount (target transport amount) is detected by the rotary encoder 52, so that the paper is transported by the target transport amount.

Incidentally, when, of the upstream-side transport rollers 23 and the downstream-side transport rollers 25, only the downstream-side transport rollers 25 are caused to perform the transport operation, a rotation amount of the paper discharge roller 25a is detected. Then, the controller 60 rotates the paper discharge roller 25a until the rotation amount reaches a rotation amount corresponding to the target transport amount.

### Regarding Transportation Error

It is the rotation amount of the paper carry roller 23a that the rotary encoder 52 detects directly. Strictly speaking, the rotary encoder 52 does not detect a transport amount of the paper S. Accordingly, if the rotation amount of the paper carry roller 23a does not agree with the transport amount of the paper S, the rotary encoder 52 cannot precisely detect the transport amount of the paper S, so that transportation error (detection error) is generated. There are two types of transportation error, namely, DC component transportation error and AC component transportation error.

The DC component transportation error refers to a certain amount of transportation error generated when the paper carry roller 23a has performed a full rotation. It can be considered that the DC component transportation error is caused because the circumference of the paper carry roller 23a is different in each individual printer due to deviation in production and the like. In other words, the DC component transportation error is transportation error that is caused because a design circumference of the paper carry roller 23a is different from an actual circumference of the paper carry roller 23a. The DC component transportation error is constant regardless of a starting position when the paper carry roller 23a performs a full rotation. However, due to effects of paper friction and the like (to be described later), the actual DC component transportation error is a value that varies depending on a total transport amount of the paper. In other words, the actual DC component transportation error is a value that varies according to a relative positional relationship between the paper S and the paper carry roller 23a (or, the paper S and the head 41).

The AC component transportation error refers to transportation error corresponding to a location that is on a circumferential face of the paper carry roller 23a and is used during transport. The AC component transportation error varies in amount depending on the location that is on the circumferential face of the paper carry roller 23a and is used during transport. In other words, the AC component transportation error is an amount that varies according to a rotating position of the paper carry roller 23a when transport starts and the transport amount.

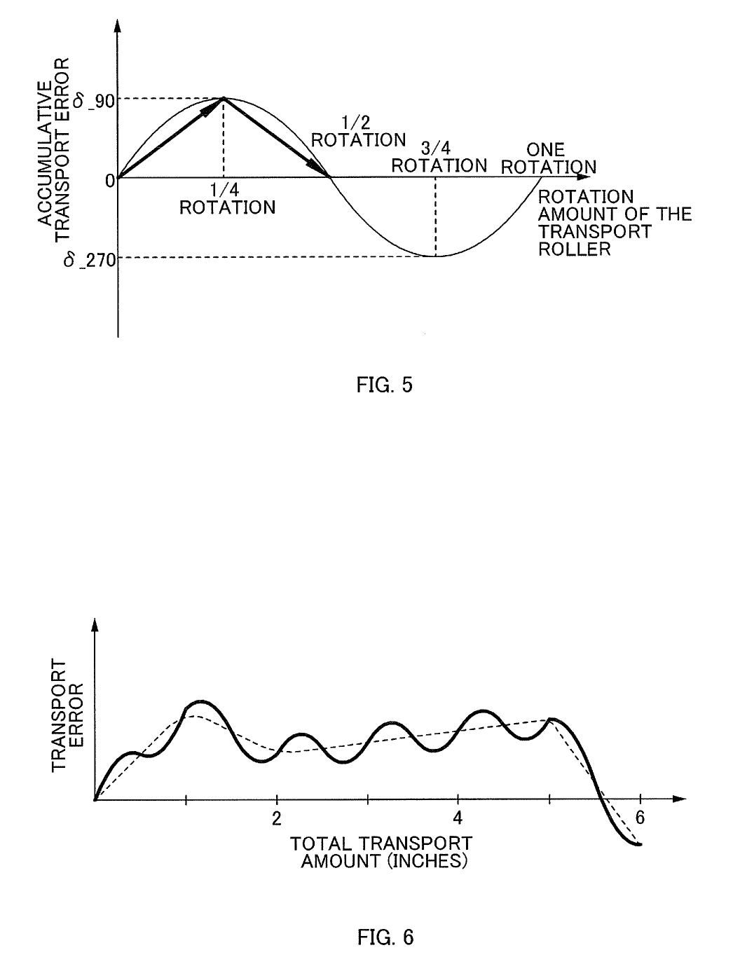

FIG. 5 is a graph for illustrating the AC component transportation error. The horizontal axis indicates the rotation amount of the paper carry roller 23a from a reference rotating position. The vertical axis indicates the transportation error. When the graph is differentiated, the transportation error produced when the paper carry roller 23a performs transport at a corresponding rotating position is deduced. Here, the accumulative transportation error at a reference position is set to zero, and the DC component transportation error is also set to zero. When the paper carry roller 23a performs a ¼ rotation from the reference position, a transportation error of δ_{—}90 occurs and the paper is transported by ¼ inch+δ_{—}90. However, when the paper carry roller 23a performs a further ¼ rotation, a transportation error of −δ_{—}90 occurs and the paper is transported by ¼ inch −δ_{—}90. The following three causes for example are conceivable as causes of the AC component transportation error.

First, influence due to a shape of the paper carry roller 23a is conceivable. For example, if the paper carry roller 23a is elliptical or egg shaped, a distance to a rotation center is different depending on the location that is on the circumferential face of the paper carry roller 23a. When a medium is transported by a portion where the distance to the rotation center is long, the transport amount increases with respect to the rotation amount of the paper carry roller 23a. On the other hand, when a medium is transported by a portion where the distance to the rotation center is short, the transport amount decreases with respect to the rotation amount of the paper carry roller 23a.

Secondly, the eccentricity of a rotational axis of the paper carry roller 23a is conceivable. Also, in this case, the distance to the rotation center is different depending on the location that is on the circumferential face of the paper carry roller 23a. Thus, even if the rotation amount of the paper carry roller 23a is the same, the transport amount is different depending on the location that is on the circumferential face of the paper carry roller 23a.

Thirdly, it is conceivable that the rotational axis of the paper carry roller 23a does not agree with the center of the scale 521 of the rotary encoder 52. In this case, the scale 521 rotates eccentrically. As a result thereof, a rotation amount of the paper carry roller 23a for a detected pulse signal is different depending on a location that is of the scale 521 and is detected by the detection section 522. For example, if the detected location of the scale 521 is apart from the rotational axis of the paper carry roller 23a, the rotation amount of the paper carry roller 23a for the detected pulse signal is small so that the transport amount is small. On the other hand, the detected location of the scale 521 is close to the rotational axis of the paper carry roller 23a, the rotation amount of the paper carry roller 23a for the detected pulse signal is large so that the transport amount is large.

Because of the above-mentioned causes, the AC component transportation error is substantially sinusoidal as shown in FIG. 5.

As a transportation error, in addition to the above-mentioned the DC component transportation error and the AC component transportation error, there is a transportation error caused by the rear end of the paper S coming off rollers. The coming-off-roller transportation error is a transportation error generated at a moment when the rear end of the paper S comes off a sandwich section of the upstream-side transport rollers 23 (a portion where the paper carry roller 23a and the driven roller 23b contacts).

When the paper S is transported by both sets of rollers, namely, the upstream-side transport rollers 23 and the downstream-side transport rollers 25, an attitude of the paper S is stable. In contrast, when the rear end of the paper S sandwiched between both sets of rollers comes off the sandwich section of the upstream-side transport rollers 23, the attitude of the paper S suddenly changes because the paper S is sandwiched between only the downstream-side transport rollers 25. As a result of the sudden change of the paper S attitude, for example, there are cases where the rear end side of the paper S that has come off the sandwich section wraps temporarily around the paper carry roller 23a that is rotating. Thereafter, the rear end side of the paper S is transported by the downstream-side transport rollers 25 and comes off the paper carry roller 23a; then, the transportation error is generated because wrapping of the rear end of the paper S around the paper carry roller 23a decreases the transport amount of the paper S. In this way, the coming-off-roller transportation error is generated due to the sudden change of the paper S attitude when the rear end of the paper S comes off the sandwich section of the upstream-side transport rollers 23. The coming-off-roller transportation error is a transportation error that is greatly generated in an instant.

Transportation Error to be Corrected in this Embodiment

FIG. 6 is a graph (conceptual graph) of a transportation error that is generated when paper of 101.6 mm×152.4 mm (4 inch×6 inch) is transported. The horizontal axis in the graph indicates the total transport amount of the paper. The vertical axis in the graph indicates the transportation error. The dashed line in the figure is a graph of the DC component transportation error. The AC component transportation error is obtained by subtracting a value of the dashed line (DC component transportation error) in the figure from a value of the solid line (total transportation error) in the figure. The AC component transportation error is substantially sinusoidal regardless of the total transport amount of the paper. On the other hand, due to effects of paper friction and the like, the DC component transportation error indicated by the dashed line is a value that varies depending on the total transport amount of the paper.

As mentioned above, the AC component transportation error is different depending on the location that is on the circumferential face of the paper carry roller 23a. Thus, even when transporting the same paper, the AC component transportation error is different if the rotating position of the paper carry roller 23a in starting the transportation is different. Accordingly, the total transportation error (transportation error indicated by the solid line in the graph) is different. In contrast, unlike the AC component transportation error, the DC component transportation error is independent of the location that is on the circumferential face of the paper carry roller 23a. Therefore, even if the rotating position of the paper carry roller 23a in starting the transportation is different, the transportation error (DC component transportation error) generated when the paper carry roller 23a has performed a full rotation is the same.

Furthermore, when attempting to correct the AC component transportation error, it is necessary for the controller 60 to detect the rotating position of the paper carry roller 23a. However, in order to detect the rotating position of the paper carry roller 23a, it is necessary to further prepare an origin sensor for the rotary encoder 52, which results in increased costs. Consequently, in the transport amount correction according to this embodiment described below, the DC component transportation error is corrected.

On the other hand, the DC component transportation error is a value that varies (see the dashed line in FIG. 6) depending on the total transport amount of the paper (In other words, the relative positional relationship between the paper S and the paper carry roller 23a). For this reason, if a greater number of correction values can be prepared corresponding to positions in the transport direction, fine corrections of transportation error can be achieved. Accordingly, in this embodiment, correction values for correcting the DC component transportation error are prepared for each ⅛ inch range rather than for each one inch range that corresponds to a full rotation of the paper carry roller 23a.

Besides, in this embodiment, correction values for correcting the coming-off-roller transportation error are also prepared. This is because the coming-off-roller transportation error cannot properly be corrected with the correction values for correcting the DC component transportation error, due to the above-mentioned characteristic of the coming-off-roller transportation error, which is a transportation error that is greatly generated in an instant.

### Outline Description

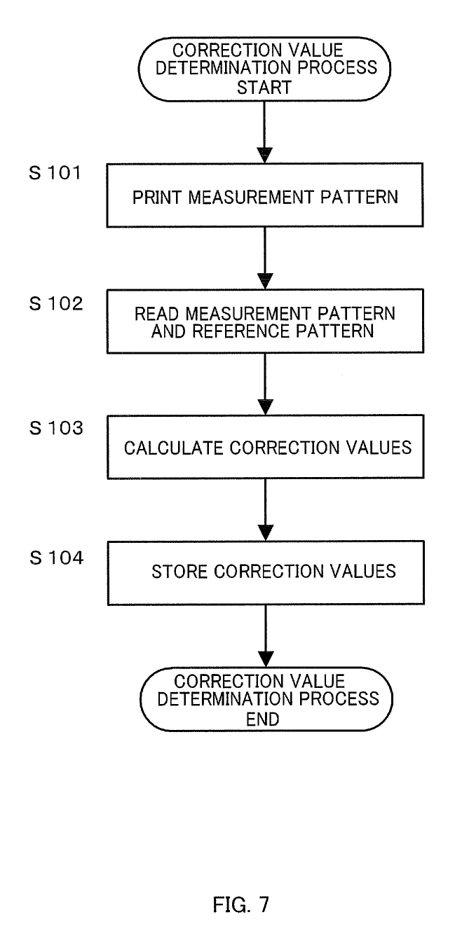

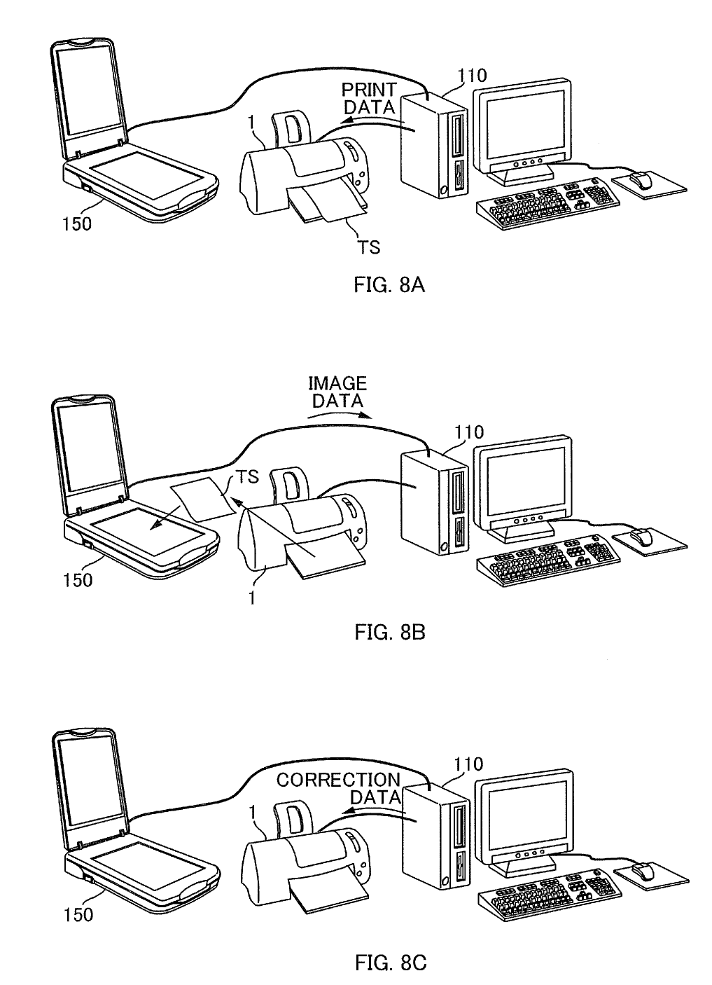

FIG. 7 is a flowchart showing up to determining the correction values for correcting transport amounts. FIGS. 8A through 8C are explanatory diagrams of conditions up to determining the correction values. These processes are carried out in an inspection process at a printer manufacturing factory. Prior to this process, an inspector connects the printer 1 that is fully assembled to the computer 110 at the factory. The computer 110 at the factory is connected to a scanner 150, and is preinstalled with a printer driver, a scanner driver, and a program for obtaining correction values.

First, the printer driver sends print data to the printer 1, and the printer 1 prints a measurement pattern on a test sheet TS serving as a medium (S101, FIG. 8A). Next, the inspector sets the test sheet TS in the scanner 150, and the scanner driver causes the scanner 150 to read the measurement pattern so that image data is obtained (S102, FIG. 8B). A reference sheet is set in the scanner 150 along with the test sheet TS, and a reference pattern drawn on the reference sheet is also read together.

Then, the program for obtaining correction values analyzes the obtained image data, calculates correction values (S103). The program for obtaining correction values sends the correction data to the printer 1, the correction values are stored in the memory 63 of the printer 1 (FIG. 8C). The correction values stored in the printer reflects the transport characteristics of each individual printer.

The printer that stores the correction values is packaged and shipped to a user. When the user prints an image with the printer, the printer transports paper based on the correction value, and prints the image onto the paper.

### Measurement Pattern Printing (S101)

First, printing of the measurement pattern is described. As with ordinary printing, the printer 1 prints the measurement pattern on paper by alternately repeating a dot forming process in which a dot is formed by ejecting ink from moving nozzles, and a transport operation in which the paper is transported in the transport direction. Note that in the description hereinafter, the dot forming process is referred to as a “pass”, and an n-th dot forming process is referred to as “pass n”.

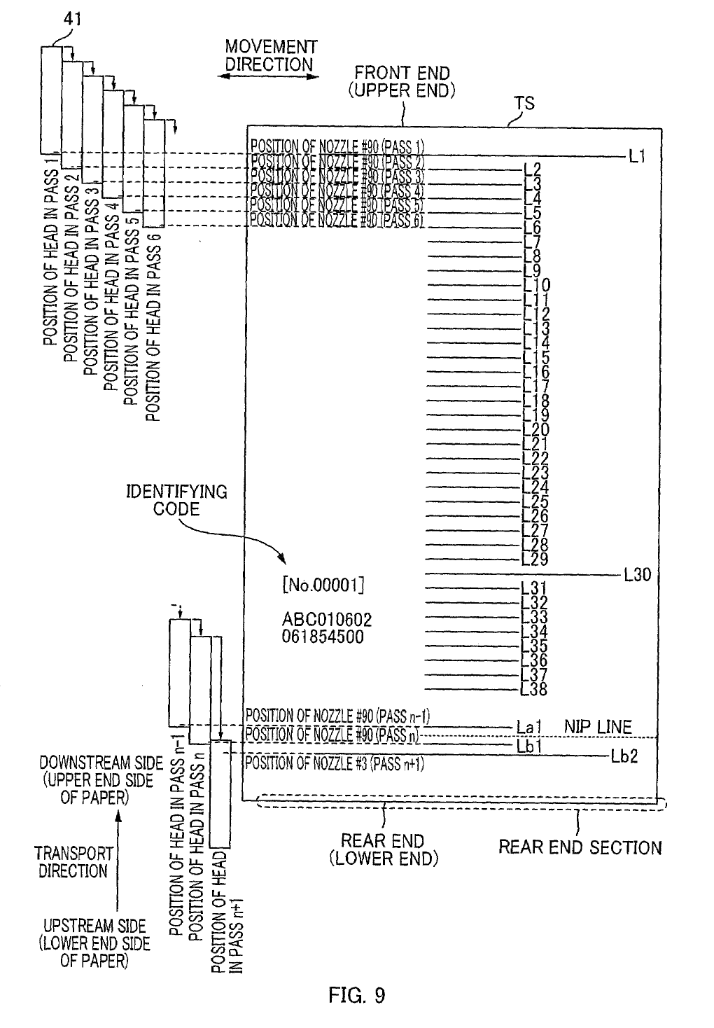

FIG. 9 is an explanatory diagram illustrating a state of printing the measurement pattern. A size of the test sheet TS on which the measurement pattern is to be printed is 101.6 mm×152.4 mm (4 inch×6 inch).

The measurement pattern to be printed on the test sheet TS is shown on the right side of the figure. The rectangles on the left side of the figure indicates a position (relative position with respect to the test sheet TS) of the head 41 at each pass. To facilitate description, the head 41 is illustrated as if moving with respect to the test sheet TS. However, the figure shows a relative positional relationship between the head and the test sheet TS; in fact, the test sheet TS is intermittently transported in the transport direction.

When the test sheet TS continues to be transported, a lower end of the test sheet TS passes over the upstream-side transport rollers 23 (the paper carry roller 23a and the driven roller 23b). The position on the test sheet TS opposing the most upstream nozzle #90 when the lower end of the test sheet TS passes over the upstream-side transport rollers 23 (specifically, the sandwich section of the upstream-side transport rollers 23) is shown by a dotted line as an “NIP line”. That is, in passes where the head 41 is higher than the NIP line in the figure, printing is carried out in a state in which the test sheet TS is sandwiched between the paper carry roller 23a and the driven roller 23b (also referred to as an “NIP state”). Further, in passes where the head 41 is lower than the NIP line in the figure, printing is carried out in a state in which the test sheet TS is not between the paper carry roller 23a and the driven roller 23b (a state in which the test sheet TS is transported by only the paper discharge roller 25a and the driven roller 25b; also referred to as a “non-NIP state”).

The measurement pattern is constituted by an identifying code and a plurality of lines.

The identifying code is a symbol for individual identification for identifying each of the individual printers 1 respectively. The identifying code is also read together when the measurement pattern is read at S102, and is identified in the computer 110 using OCR character recognition.

Each of the lines is formed in the movement direction. A large number of lines are formed on an upper end side from the NIP line. The plurality of lines on the upper end side from the NIP line are numbered “Li” in order from the upper end side for each i-th line; a line closest to the NIP line (line positioned furthest on the lower end side, among the plurality of lines on the upper end side from the NIP line) is referred to as La1. Further, two lines are formed on the lower end from the NIP line. Of two lines closer to the lower end than the NIP line, the upper end side line is referred to as Lb1, and the lower end side line (lowest line) is referred to as Lb2. Specific lines are formed longer than other lines. For example, line L1, line L30, and line Lb2 are formed longer compared to the other lines. These lines are formed as follows.

First, after the test sheet TS is transported to a certain print start position, ink droplets are ejected from only the nozzle #90 in pass 1, to form line L1. After pass 1, the controller 60 causes the paper carry roller 23a to perform a ⅛ rotation so that the test sheet TS is transported by approximately ⅛ inch. After transport, ink droplets are ejected from only the nozzle #90 in pass 2, to form line L2. Thereafter, the same operation is repeated, and line L1 through line L38 are formed at intervals of approximately ⅛ inch. In this manner, line L1 through line L38, which are closer to the upper end side than the NIP line, are formed using the most upstream nozzle #90 of the nozzles #1 through #90. In this way, the most lines possible can be formed on the test sheet TS in the NIP state. Though the line L1 through line L38 are formed using only the nozzle #90, nozzles other than the nozzle #90 are used when printing the identifying code in a pass in which the identifying code is printed.

Further, immediately before the lower end of the test sheet TS has passed the upstream-side transport rollers 23 (the paper carry roller 23a and the driven roller 23b), ink droplets are ejected from only the nozzle #90 in pass n−1, to form line La1. In this embodiment, setting is made in such a manner as line La1 is formed when a rear end section of the test sheet TS (an end section on the upstream side of the test sheet TS in the transport direction) is sandwiched with the sandwich section of the upstream-side transport rollers 23. The rear end section refers to a section including the rear end of the test sheet TS and its periphery.

After pass n−1, the controller 60 causes the paper carry roller 23a to perform a ⅙ rotation (as is described later, since transition from the NIP state to the non-NIP state is carried out during this rotation, of the upstream-side transport rollers 23 and the downstream-side transport rollers 25, only the downstream-side transport rollers 25 transport paper at this stage). Thereby, the test sheet TS is transported by approximately ⅙ inch. Then, after the rear end section of the test sheet TS has passed the upstream-side transport rollers 23, ink droplets are ejected from only the nozzle #90 in pass n, and thereby line Lb1 is formed onto the test sheet TS whose rear end section is not sandwiched with the sandwich section of the upstream-side transport rollers 23.

That is, in pass n−1, printing is carried out in the NIP state to form line La1; in pass n, printing is carried out in the non-NIP state to form line Lb1. And to ensure this occurs, the dot forming process timings are set for pass n−1 and pass n. Consequently, a transport amount of the test sheet TS between pass n−1 and pass n is ⅙ inch, which is larger than a transport amount of a process in which each of lines L1 through L38 is formed (that is, ⅛ inch), and is smaller than a transport amount of the test sheet TS when the upstream-side transport rollers perform one rotation (that is, 1 inch).

Further still, after ink droplets are ejected from only the nozzle #90 in pass n and line Lb1 is formed, the controller 60 causes the paper discharge roller 25a to rotate so that the test sheet TS is transported by approximately 1 inch. After this transport, ink droplets are ejected from only a nozzle #3 in pass n+1 and line Lb2 is formed. Supposing the nozzle #1 is used, the interval between line Lb1 and line Lb2 will be extremely narrow (approximately 1/90 inch), which will make measuring difficult when the interval between line Lb1 and line Lb2 is measured. For this reason, in this embodiment, the interval between line Lb1 and line Lb2 is widen by forming line Lb2 using nozzle #3, which is closer to the upstream side than the nozzle #1 in the transport direction, thereby facilitating measurement.

Incidentally, when transport of the test sheet TS is carried out ideally, the interval between lines from line L1 through line L38 should be precisely ⅛ inch. However, when there is transportation error, the line interval is not ⅛ inch. If the test sheet TS is transported more than an ideal transport amount, then the line interval widens. Conversely, if the test sheet TS is transported less than the ideal transport amount, then the line interval narrows. That is, the interval between certain two lines reflects the transportation error in transport operation carried out between a pass in which one of the lines is formed and a pass in which the other of the lines is formed. For this reason, by measuring the interval between two lines, it is possible to measure the transportation error in the transport operation carried out between a pass in which one of the lines is formed and a pass in which the other of the lines is formed.

Similarly, the interval between line La1 and line Lb1 should be precisely ⅙ inch when transport of the test sheet TS is carried out ideally. However, when there is transportation error, the line interval is not ⅙ inch. For this reason, it is conceivable that the interval between line La1 and line Lb1 reflects transportation error in the transport operation at a time of a transition from the NIP state to the non-NIP state. Therefore, if the interval between line La1 and line Lb1 is measured, it is possible to measure transportation error in the transport operation at the time of a transition from the NIP state to the non-NIP state. That is, line La1 and line Lb1 are a pattern for correcting transportation error of the test sheet TS (coming-off-roller transportation error) when the test sheet TS whose rear end section is sandwiched with the sandwich section is transported in such a manner as the rear end section is positioned closer to the downstream side than the sandwich section in the transport direction. In this embodiment, line La1 corresponds to the first pattern, and line Lb1 corresponds to the second pattern.

Furthermore, the interval between line Lb1 and line Lb2 should be precisely 3/90 inch when transport of the test sheet TS is carried out ideally (or more accurately, also when the ejection of ink from the nozzle #90 and the nozzle #3 is identical). However, when there is transportation error, the line interval is not 3/90 inch. For this reason, it is conceivable that the interval between line Lb1 and line Lb2 reflects transportation error in the transport operation in the non-NIP state. For this reason, if the interval between line Lb1 and line Lb2 is measured, it is possible to measure the transportation error in the transport operation in the non-NIP state.

### Pattern Reading (S102)

### Configuration of Scanner

First, a configuration of the scanner 150 used for reading the measurement pattern is described.

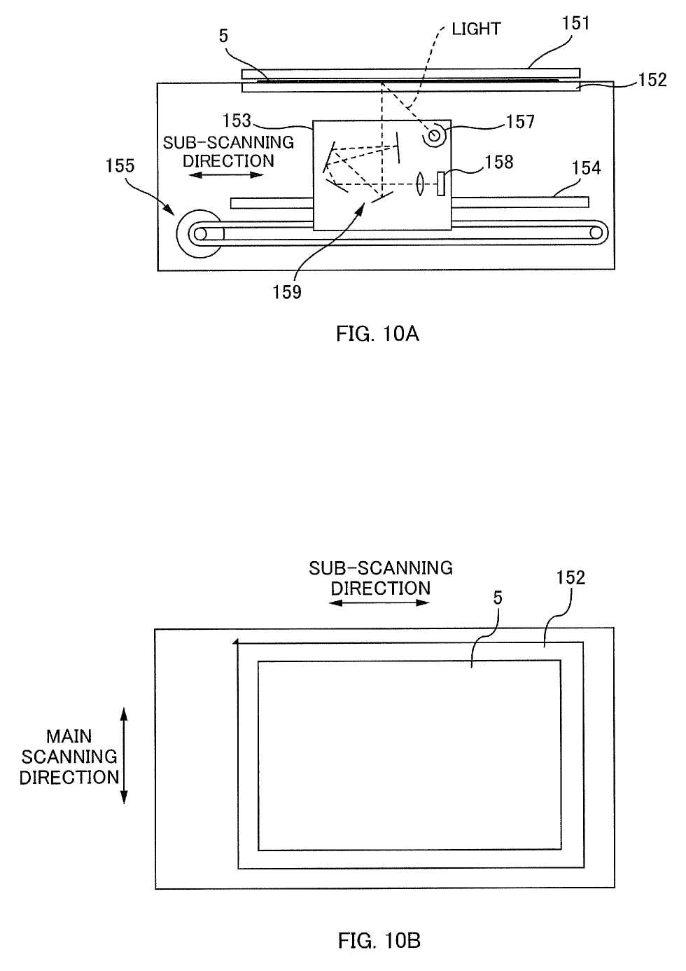

FIG. 10A is a vertical sectional view of the scanner 150.

FIG. 10B is a top view of the scanner 150 with a lid 151 detached.

The scanner 150 is provided with the lid 151, a document platen grass 152 on which a document 5 is placed, a reading carriage 153 that faces the document 5 through the document platen grass 152 and that moves in a sub-scanning direction, a guiding section 154 guiding the reading carriage 153 in the sub-scanning direction, a movement mechanism 155 for moving the reading carriage 153, and a scanner controller (not shown) that controls the various units in the scanner 150. The reading carriage 153 is provided with an exposure lamp 157 that shines light on the document 5, a line sensor 158 that detects a line image in a main scanning direction (the direction normal to the surface of the paper on which the figure is described in FIG. 10A), and an optical device 159 for leading the reflected light from the document 5 to the line sensor 158. Dashed lines in the reading carriage 153 shown in the figure show the path of light.

In order to read an image of the document 5, an operator raises the lid 151, places the document 5 on the document platen grass 152, and lowers the lid 151. The scanner controller moves the reading carriage 153 in the sub-scanning direction with the exposure lamp 157 emitting light, and the line sensor 158 reads the image on a surface of the document 5. The scanner controller transmits the read image data to the scanner driver of the computer 110, and thereby the computer 110 obtains the image data of the document 5.

### Reading Position Accuracy

As is described below, in this embodiment, the scanner 150 reads the measurement pattern in the test sheet TS and the reference pattern in the reference sheet, with resolution of 720 dpi (main scanning direction)×720 dpi (sub-scanning direction). Accordingly, the below description is made on condition that an image is read with resolution of 720×720 dpi.

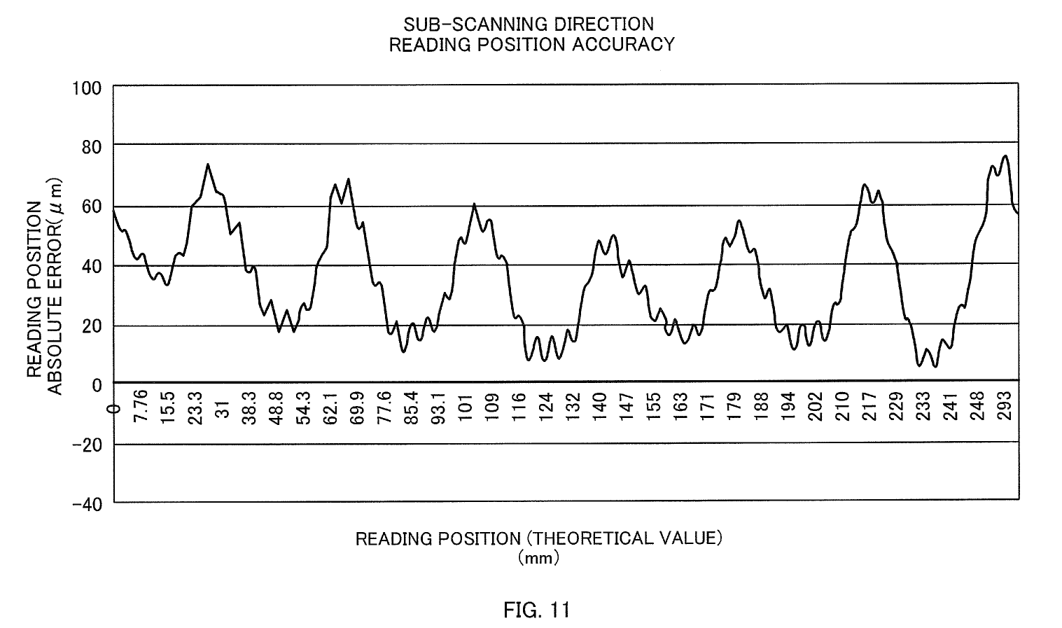

FIG. 11 is a graph showing reading position error of the scanner. The horizontal axis in the graph indicates reading positions (theoretical values) (that is, the horizontal axis in the graph indicates positions (theoretical values) of the reading carriage 153). The vertical axis in the graph indicates reading position error (difference between the theoretical value of the reading position and an actual reading position). For example, when the reading carriage 153 is caused to move 1 inch (=25.4 mm), an error of approximately 60 μm is produced.

Suppose that if the actual reading position agrees with the theoretical value of the reading position, a pixel that is 720 pixels apart in the sub-scanning direction from a pixel indicating a reference position (a position where the reading position is zero) should indicate an image in a position precisely one inch from the reference position. However, when reading position error occurs as shown in the graph, the pixel that is 720 pixels apart in the sub-scanning direction from the pixel indicating the reference position indicates an image in a position that is further 60 μm apart from the position that is one inch apart from the reference position.

Furthermore, suppose that there is zero tilt in the graph, the image should be read having a uniform interval each 1/720 inch. However, when the graph is tilted to the positive side, the image is read at an interval longer than 1/720 inch. And when the graph is tilted to the negative side, the image is read at an interval shorter than 1/720 inch.

As a result, even supposing lines of the measurement pattern are formed having uniform intervals, line images in the image data will not have uniform intervals in a state in which there is reading position error. In this manner, in a state in which there is reading position error, line positions cannot be accurately measured by simply reading the measurement pattern.

Accordingly, in this embodiment, when the test sheet TS is set and the measurement pattern is read by the scanner, the reference sheet is set and also read.

### Reading of Measurement Pattern and Reference Pattern

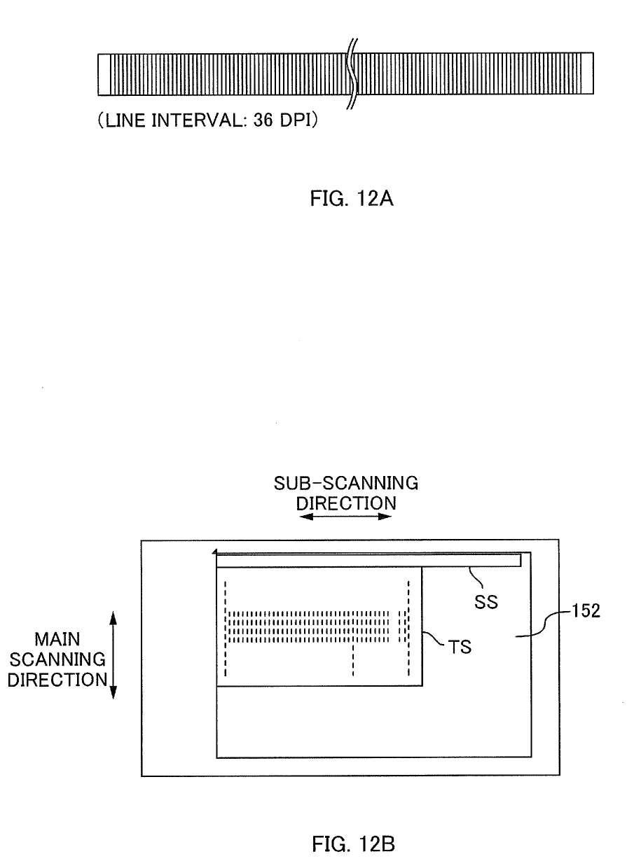

FIG. 12A is an explanatory diagram of a reference sheet SS.

FIG. 12B is an explanatory diagram of condition in which the test sheet TS and the reference sheet SS are set on the document platen grass 152.

A size of the reference sheet SS is 10 mm×300 mm, and the reference sheet SS has a long narrow shape. A large number of lines are formed as a reference pattern at intervals of 36 dpi on the reference sheet SS. Since the reference sheet SS is used repetitively, it is made not of paper but of a PET film. Furthermore, the reference pattern is formed with high precision using laser processing.

The test sheet TS and the reference sheet SS are set in a certain position on the document platen grass 152 using a jig not shown in the drawings. The reference sheet SS is set on the document platen grass 152 in such a manner as its long sides are parallel to the sub-scanning direction of the scanner 150, that is, in such a manner as each line of the reference sheet SS is parallel to the main scanning direction of the scanner 150. The test sheet TS is set beside the reference sheet SS. The test sheet TS is set on the document platen grass 152 in such a manner as its long sides are parallel to the sub-scanning direction of the scanner 150, that is, in such a manner as each line of the measurement pattern is parallel to the main scanning direction.

With the test sheet TS and the reference sheet SS set in this manner, the scanner 150 reads the measurement pattern and the reference pattern. At this time, due to the influence of reading position error, an image of the measurement pattern in the reading result is a distorted image compared to the actual measurement pattern. Similarly, an image of the reference pattern is also a distorted image compared to the actual reference pattern.

Note that the image of the measurement pattern in the reading result is affected not only by reading position error, but also by the transportation error of the printer 1. On the other hand, the reference pattern is formed having uniform intervals without any relation to the transportation error of the printer, and therefore the image of the reference pattern is affected by the reading position error of the scanner 150, but is not affected by the transportation error of the printer 1.

Accordingly, when calculating correction values based on the image of the measurement pattern, the program for obtaining correction values cancels the influence of reading position error in the image of the measurement pattern based on the image of the reference pattern.

### Calculation of Correction Values (S103)

Before describing the calculation of correction values, the image data obtained from the scanner 150 is described. The image data consists of a plurality of pieces of pixel data. Each piece of pixel data indicates a tone value of a corresponding pixel. Ignoring scanner reading error, each pixel corresponds to a size of 1/720 inch× 1/720 inch. An image (digital image) consists of pixels such as these as a smallest structural unit, and image data is data that represents an image such as this.

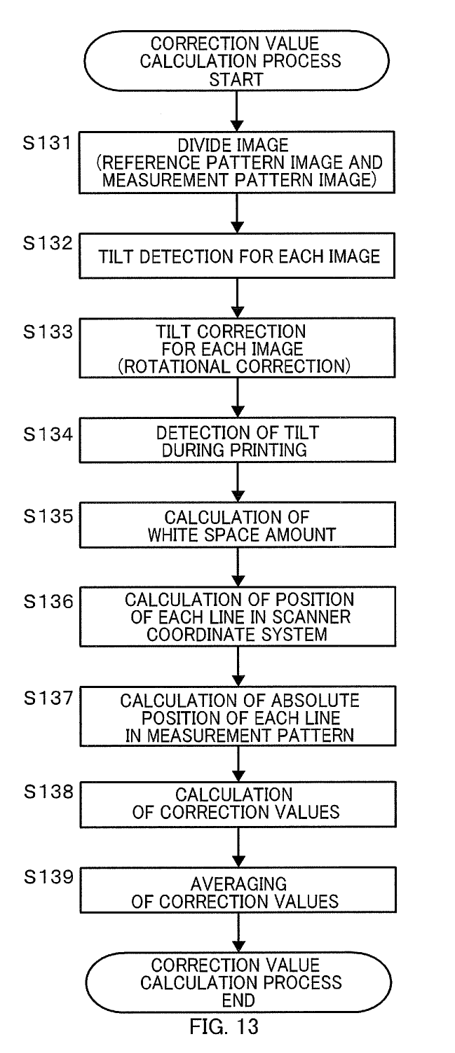

FIG. 13 is a flowchart of a correction value calculating process in S103. The computer 110 executes each process in accordance with the program for obtaining correction values. That is, the program for obtaining correction values contains code for causing the computer 110 to execute each process.

### Image Division (S131)

First, the computer 110 divides into two the image represented by the image data obtained from the scanner 150 (S131).

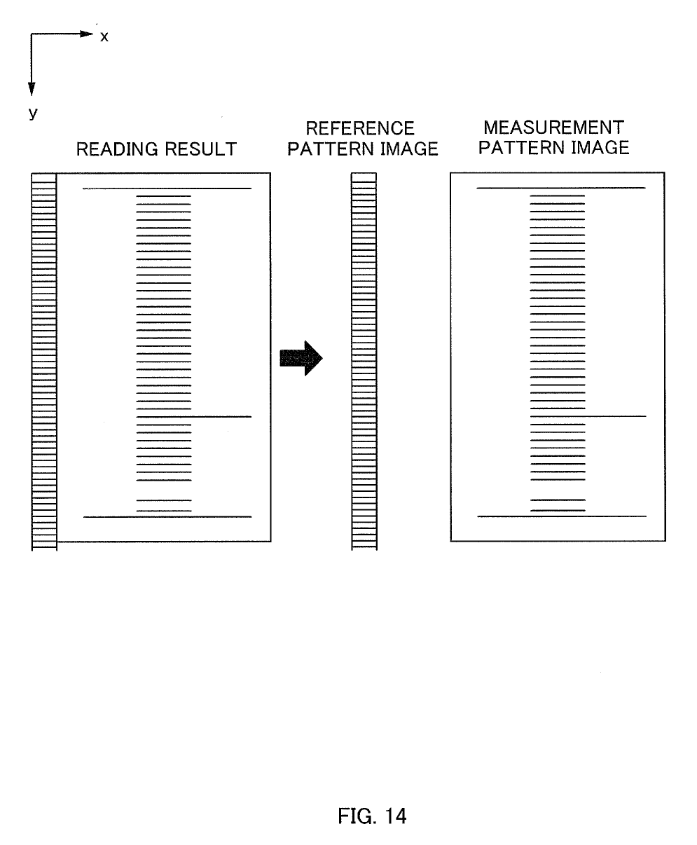

FIG. 14 is an explanatory diagram of image division (S131). On the left side of the figure, an image represented by image data obtained from the scanner is depicted. On the right side of the figure, a divided image is depicted. In the following description, the right-to-left direction (horizontal direction) in the figure is referred to as an x-direction, and an up-and-down direction (vertical direction) in the figure is referred to as a y-direction. The lines in the image of the reference pattern are substantially parallel to the x-direction, and the lines in the image of the measurement pattern are also substantially parallel to the x-direction.

The computer 110 divides the image into two by extracting an image of a certain range from the image of the reading result. By dividing the image of the reading result into two, one of the images indicates the image of the reference pattern, and the other of the images indicates the image of the measurement pattern. A reason for dividing in this manner is that since there is a risk that the reference sheet SS and the test sheet TS are set in the scanner 150 with different tilts, tilt correction (S133) is performed on these separately.

### Image Tilt Detection (S132)

Next, the computer 110 detects the tilt of the image (S132).

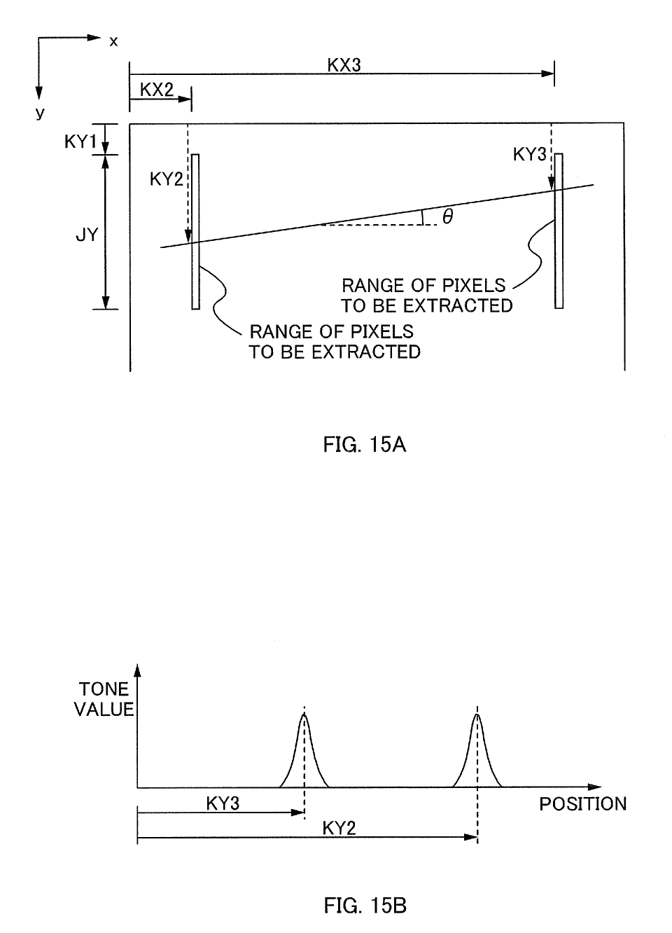

FIG. 15A is an explanatory diagram showing how tilt of an image of the measurement pattern is detected. From the image data, the computer 110 extracts JY number of pixels which are located KX2-th from the left and KY1-th and lower from the top. Similarly, from the image data, the computer 110 extracts JY number of pixels which are located KX3-th from the left and KY1-th and lower from the top. Note that the parameters KX2, KX3, KY1 and JY are set in such a manner as pixels indicating line L1 are contained in the extracted pixels.

FIG. 15B is a graph of tone values of extracted pixels. The horizontal axis indicates pixel position (y coordinates). The vertical axis indicates the tone values of the pixels. The computer 110 obtains centroid positions KY2 and KY3 respectively based on pixel data of the JY number of pixels that have been extracted.

Then, the computer 110 calculates a tilt θ of line L1 using the following expression:

θ=tan⁻¹{(KY2−KY3)/(KX2−KX3)}

Note that the computer 110 detects not only the tilt of the image of the measurement pattern but also the tilt of the image of the reference pattern. A method for detecting the tilt of the image of the reference pattern is substantially the same as the method described above, and therefore its description is omitted.

### Image Tilt Correction (S133)

Next, the computer 110 corrects the image tilt by performing a rotation process on the image based on the tilt θ detected at S132 (S133). The image of the measurement pattern is rotationally corrected based on the tilt result of the image of the measurement pattern, and the image of the reference pattern is rotationally corrected based on the tilt result of the image of the reference pattern.

A bilinear technique is used in an algorithm for the rotation process of the image. This algorithm is well known, and therefore its description is omitted.

### Tilt Detection During Printing (S134)

Next, the computer 110 detects the tilt (skew) during printing of the measurement pattern (S134). When the lower end of the test sheet passes the upstream-side transport rollers 23 while printing the measurement pattern, sometimes the lower end of the test sheet contacts the head 41 so that the test sheet moves. When this occurs, the correction values calculated using the measurement pattern becomes inappropriate. Therefore, whether or not the lower end of the test sheet has made contact with the head 41 is detected by detecting the tilt at the time of printing the measurement pattern, and if contact has been made, this is taken as an error.

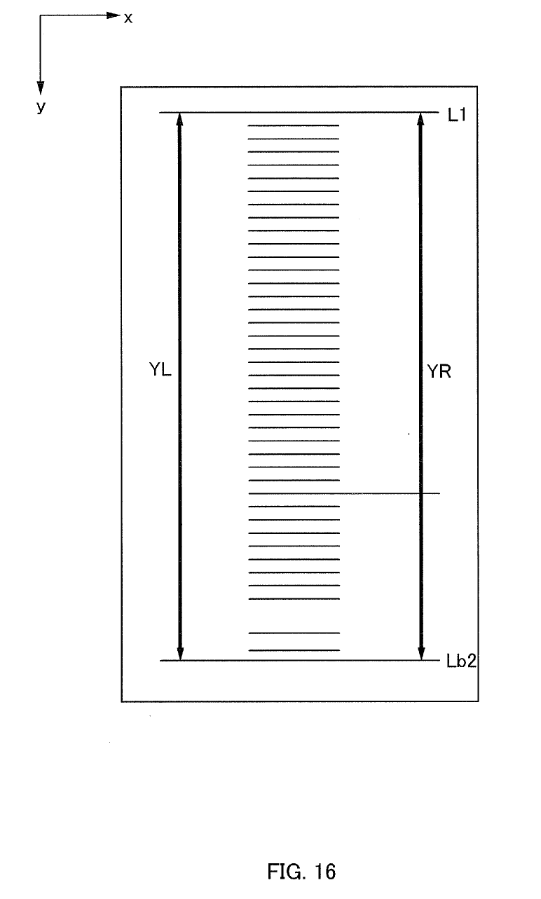

FIG. 16 is an explanatory diagram how tilt during printing of the measurement pattern is detected. First, the computer 110 detects a left side interval YL and a right side interval YR between line L1 (the uppermost line) and line Lb2 (the bottommost line, which is a line formed after the lower end has passed over the transport roller). Then, the computer 110 calculates the difference between the interval YL and the interval YR and proceeds to the next process (S135) if this difference is within a certain range, but takes it as an error if this difference is outside the certain range.

### Calculating Amount of White Space (S135)

Next, the computer 110 calculates the amount of white space (S135).

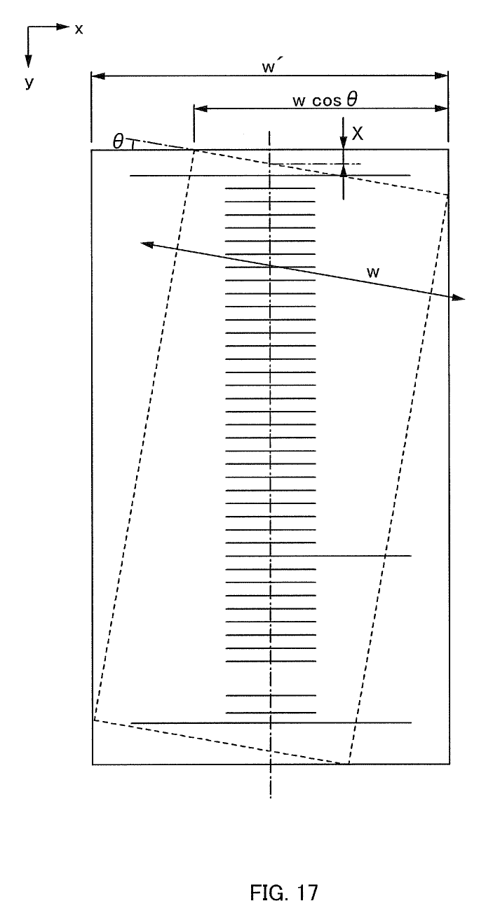

FIG. 17 is an explanatory diagram of a white space amount X. The solid line quadrilateral (outer quadrilateral) in the figure indicates an image after the rotational correction of S133. The dotted line quadrilateral in the figure (inner diagonal quadrilateral) indicates an image before the rotational correction. In order to make the image after the rotational correction a rectangular shape, white spaces of right triangle shapes are added to the four corners of the rotated image when carrying out the rotational correction process at S133.

Supposing the tilt of the reference sheet SS and the tilt of the test sheet TS are different, the added white space amount will be different. Consequently, positions of the lines in the measurement pattern with respect to the reference pattern will be relatively shifted before and after the rotational correction (S133). Accordingly, the computer 110 obtains the white space amount X using the following expression and prevents displacement of the line of the measurement pattern with respect to the reference pattern by subtracting the white space amount X from the line positions calculated in S136.

X=(w cos θ−W′/2)×tan θ

### Line Position Calculation in Scanner Coordinate System (S136)

Next, the computer 110 calculates the line positions of the reference pattern and the line positions of the measurement pattern respectively using a scanner coordinate system (S136).

The scanner coordinate system refers to a coordinate system when the size of one pixel is 1/720 inch× 1/720 inch. There is reading position error in the scanner 150 and strictly speaking an actual region corresponding to each piece of pixel data is not 1/720 inch× 1/720 inch when consideration is given to the reading position error; but, in the scanner coordinate system, the size of a region (pixel) corresponding to each piece of pixel data is assumed to be 1/720 inch× 1/720 inch. Furthermore, a position of the upper left pixel in each image is set as an origin in the scanner coordinate system.

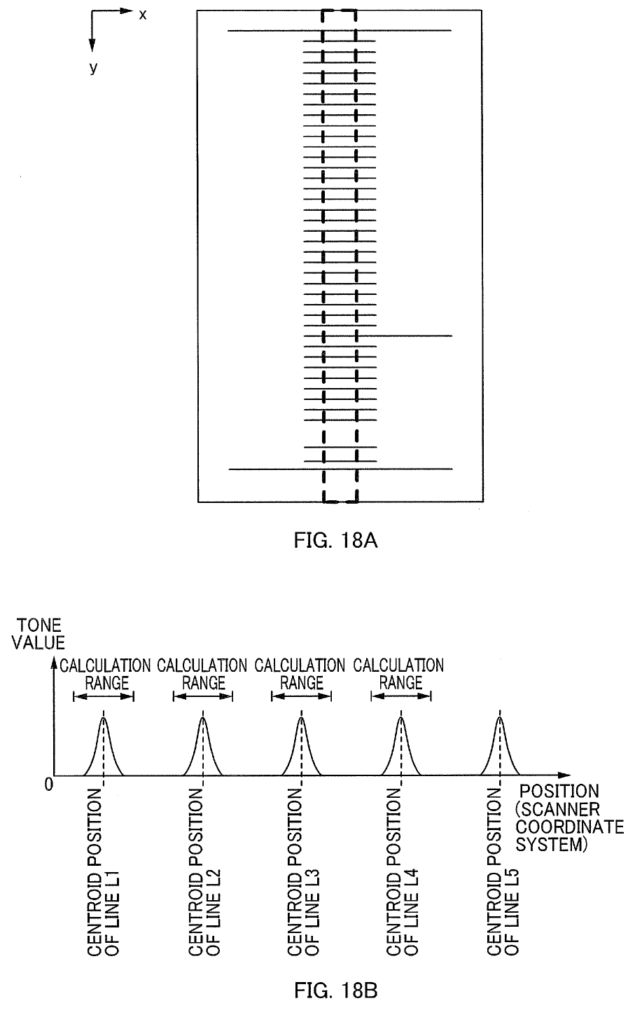

FIG. 18A is an explanatory diagram of an image range used in calculating line positions. The image data of the image in the range indicated by the dashed line in the figure is used in calculating the line positions. FIG. 18B is an explanatory diagram of calculating line positions. The horizontal axis indicates the positions in the y-direction of the pixels (scanner coordinate system). The vertical axis indicates tone values of the pixels (average values of tone values of the pixels lined up in the x-direction).

The computer 110 obtains a position of a peak value of the tone value, and sets a certain range centered on this position as a calculation range. Then, based on pixel data of pixels in this calculation range, the centroid position of the tone values is calculated, and the calculated centroid position is set as the line position.

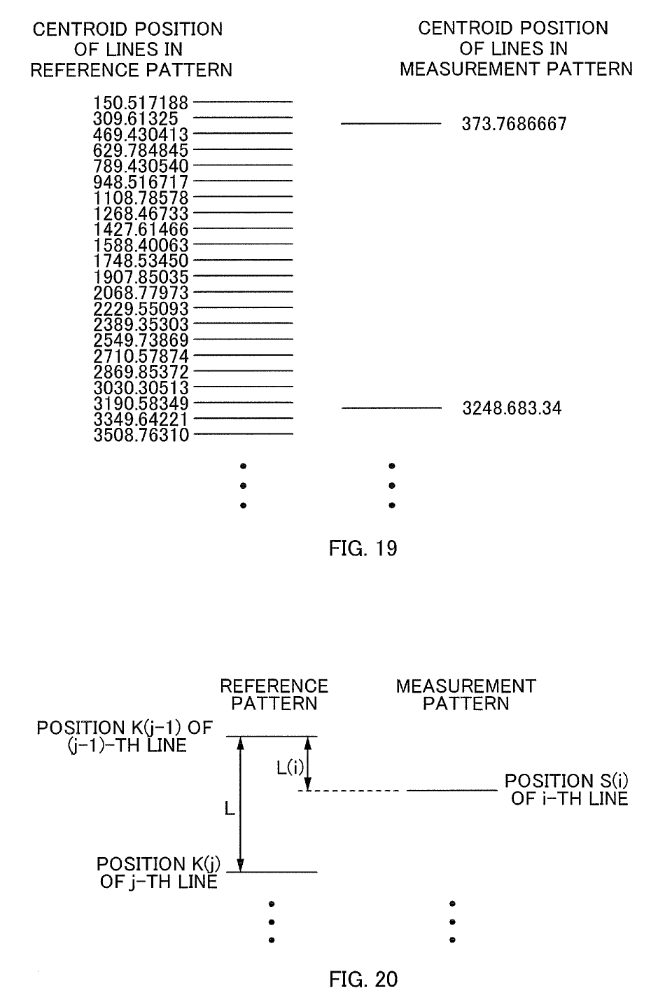

FIG. 19 is an explanatory diagram of calculated line positions (note that positions shown in the figure have undergone a certain calculation to be made dimensionless). In regard to the reference pattern, despite being constituted by lines having uniform intervals, its calculated line positions do not have uniform intervals when attention is given to the centroid positions of each line in the reference pattern. This is conceivably an influence of reading position error of the scanner 150.

### Calculating Absolute Position of Lines in Measurement Pattern (S137)

Next, the computer 110 calculates the absolute positions of the lines in the measurement pattern (S137).

FIG. 20 is an explanatory diagram of calculating an absolute position of an i-th line in the measurement pattern. Here, the i-th line in the measurement pattern is positioned between a (j−1)-th line in the reference pattern and a j-th line in the reference pattern. In the following description, the position (scanner coordinate system) of the i-th line in the measurement pattern is referred to as “S(i)” and the position (scanner coordinate system) of the j-th line in the reference pattern is referred to as “K(j)”. Further, the interval (y-direction interval) between the (j−1)-th line and the j-th line of the reference pattern is referred to as “L”, and the interval (y-direction interval) between the (j−1)-th line of the reference pattern and the i-th line of the measurement pattern is referred to as “L(i)”.

First, the computer 110 calculates a ratio H of the interval L(i) to the interval L based on the following expression:

$$\begin{matrix}H = L ( i ) / L \\ = \{ S ( i ) - K ( j - 1 ) \} / \{ K ( j ) - K ( j - 1 ) \}\end{matrix}$$

Incidentally, the reference pattern on the actual reference sheet SS has uniform intervals, and therefore when the absolute position of a first line of the reference pattern is set to zero, the position of an arbitrary line in the reference pattern can be calculated. For example, the absolute position of a second line of the reference pattern is 1/36 inch. Accordingly, when the absolute position of the j-th line in the reference pattern is defined as “J(j)” and the absolute position of the i-th line in the measurement pattern is defined as “R(i)”, then R(i) can be calculated as shown in the following expression:

R(i)={J(j)−J(j−1)}×H+J(j−1)

A specific procedure for calculating the absolute position of the first line of the measurement pattern in FIG. 19 is described below. First, based on the value (373.768667) of S(1), the computer 110 detects that the first line of the measurement pattern is positioned between the second line and the third line of the reference pattern. Next, the computer 110 calculates that the ratio H is 0.40143008 (=(373.7686667−309.613250)/(469.430413−309.613250)). Next, the computer 110 calculates that an absolute position R(1) of the first line of the measurement pattern is 0.98878678 mm (=0.038928613 inch={ 1/36 inch}×0.40143008+ 1/36 inch).

In this manner, the computer 110 calculates the absolute positions of the lines of the measurement pattern.

### Calculating Correction Value (S138)

Next, the computer 110 calculates correction values corresponding to multiple transport operations carried out when the measurement pattern is formed (S138). Each of the correction values is calculated based on a difference between a theoretical line interval and an actual line interval.

The correction values C(i) of the transport operation carried out between pass i and pass i+1 are values obtained by subtracting “R(i+1)−R(i)” (the actual interval between line Li and the absolute position of line L(i+1)) from “3.175 mm” (⅛ inch, that is, the theoretical interval between line Li and line L(i+1)). For example, the correction value C(1) of the transport operation carried out between pass 1 and pass 2 is 3.175 mm −{R(2)−R(1)}. The computer 110 calculates the correction values C(1) through C(37) in this manner.

Further, the correction value Cb1 of the transport operation carried out between pass n−1 and pass n is a value obtained by subtracting the actual interval between line La1 and the absolute position of line Lb1 from “4.23 mm” (⅙ inch, that is, the theoretical interval between line La1 and line Lb1). The computer 110 calculates the correction value Cb1 in this manner.

Further, the correction value Cb2 of the transport operation carried out between pass n and pass n+1 is a value obtained by subtracting the actual interval between line Lb1 and the absolute position of line Lb2 from “0.847 mm” ( 3/90 inch, that is, the theoretical interval between line Lb1 and line Lb2). The computer 110 calculates correction value Cb2 in this manner.

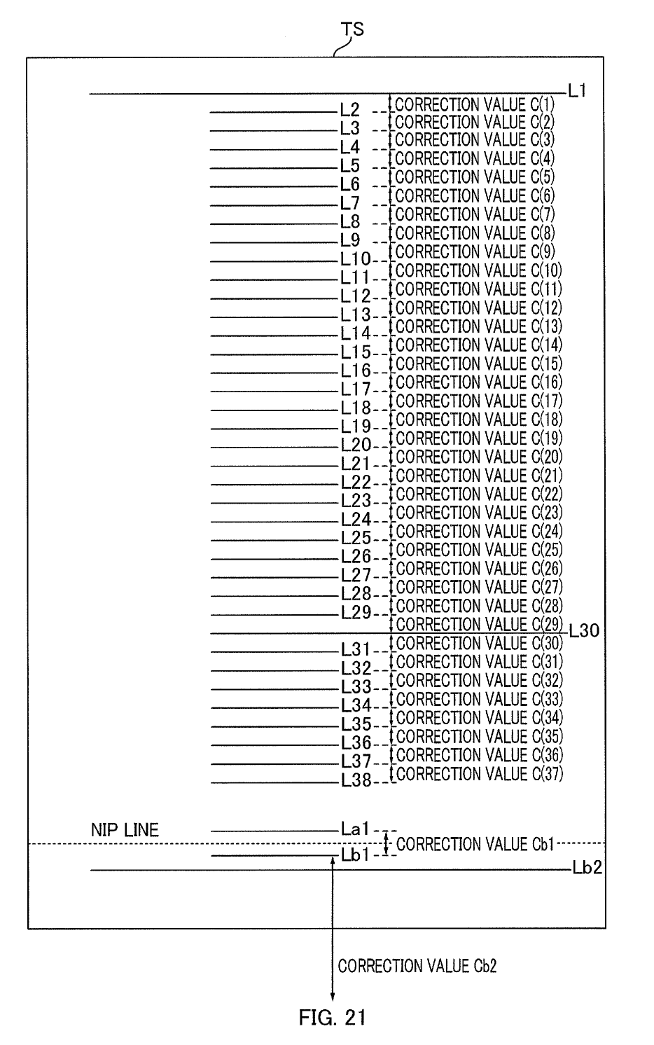

FIG. 21 is an explanatory diagram of ranges associated with the correction values C(i) and the like. Supposing that a value obtained by subtracting the correction value C(1) from the initial target transport amount is set as a target in the transport operation between pass 1 and pass 2 when printing the measurement pattern, then the actual transport amount should become precisely ⅛ inch (=3.175 mm). Similarly, supposing that a value obtained by subtracting the correction value Cb1 from the initial target transport amount is set as a target in the transport operation between pass n−1 and pass n when printing the measurement pattern, the actual transport amount should become precisely ⅙ inch. Furthermore, supposing that a value obtained by subtracting the correction value Cb2 from the initial target transport amount is set as a target in the transport operation between pass n and pass n+1 when printing the measurement pattern, the actual transport amount should become precisely 1 inch.

### Averaging Correction Value (S139)

The rotary encoder 52 of this embodiment is not provided with an origin sensor, and therefore although the controller 60 can detect the rotation amount of the paper carry roller 23a, the controller 60 does not detect the rotating position of the paper carry roller 23a. For this reason, the printer 1 cannot guarantee the rotating position of the paper carry roller 23a in starting the transportation. That is, each time printing is carried out, there is a risk the rotating position of the paper carry roller 23a is different in starting the transportation. On the other hand, the interval between two adjacent lines in the measurement pattern is affected not only by the DC component transportation error when transported by ⅛ inch, but is also affected by the AC component transportation error.

Accordingly, if a correction value that is calculated based on the interval between two adjacent lines in the measurement pattern is applied as it is when correcting the target transport amount, there is a risk that the transport amount will not be corrected properly due to the influence of the AC component transportation error. For example, even when carrying out a transport operation of a ⅛ inch transport amount between pass 1 and pass 2 in the same manner as when printing the measurement pattern, if the rotating position of the paper carry roller 23a in starting the transportation is different from that at the time of printing the measurement pattern, then the transport amount will not be corrected properly even though the target transport amount is corrected with the correction value C(1). If the rotating position of the paper carry roller 23a in starting the transportation is 180 degrees different compared to the time of printing the measurement pattern, then due to the influence of the AC component transportation error, the transport amount will not be corrected properly, and there are cases in which transportation error worsens.

Accordingly, in this embodiment, in order to correct only the DC component transportation error, a correction value Ca for correcting the DC component transportation error is calculated by averaging eight correction values C as in the following expression:

Ca(i)={C(i−3)+C(i−2)+C(i−1)+C(i)+C(i+1)+C(i+2)+C(i+3)+C(i+4)}/8

Here, description is given regarding a reason why the correction value Ca for correcting the DC component transportation error can be calculated by the above expression.

As described above, the correction values C(i) of the transport operation carried out between pass i and pass i+1 are values obtained by subtracting “R(i+1)−R(i)” (the actual interval between line Li and the absolute position of line L(i+1)) from “3.175 mm” (⅛ inch, that is, the theoretical interval between line Li and line L(i+1)). Thus, the above expression for calculating the correction value Ca possesses a meaning as in the following expression:

Ca(i)=[25.4 mm−{R(i+5)−R(i−3)}]/8

That is, the correction values Ca(i) are values obtained by dividing by eight a difference between an interval of two lines that should be separated by one inch in theory (line L(i+5) and line L(i−3)) and one inch (the transport amount of one rotation of the paper carry roller 23a). For this reason, the correction values Ca(i) are values for correcting ⅛ of the transportation error produced when the paper S is transported by one inch (the transport amount of one rotation of the paper carry roller 23a). Then, transportation error produced when the paper S is transported by one inch is the DC component transportation error, and no AC component transportation error is contained within this transportation error.

Therefore, the correction values Ca(i) calculated by averaging eight correction values C are not affected by the AC component transportation error, and are values that reflect the DC component transportation error.

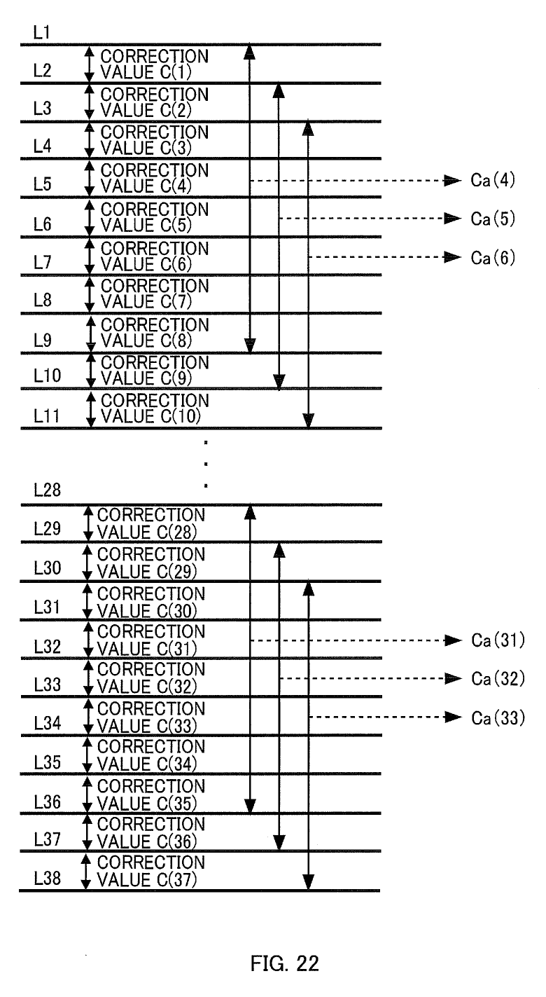

FIG. 22 is an explanatory diagram of a relationship between the lines of the measurement pattern and the correction value Ca. As shown in the figure, the correction values Ca(i) are values corresponding to an interval between line L(i+5) and line L(i−3). For example, the correction value Ca(4) is a value corresponding to the interval between the line L9 and line L1. Further, since the lines in the measurement pattern are formed at substantially each ⅛ inch, the correction value Ca can be calculated for each ⅛ inch. For this reason, each correction value Ca(i) can be set in such a manner as each correction value Ca has an application range of ⅛ inch, regardless of the value corresponding to the interval between two lines that theoretically should be separated by 1 inch. That is, in this embodiment, the correction values for correcting the DC component transportation error can be set for each ⅛ inch rather than for each one inch range corresponding to one rotation of the paper carry roller 23a. In this way, fine corrections can be performed on the DC component transportation error (see dashed line in FIG. 6), which fluctuates in response to the total transport amount.

It should be noted that the correction value Ca(4) of the transport operation carried out between pass 4 and pass 5 is calculated to be a value obtained by dividing a sum total of the correction values C(1) through C(8) by eight (an average value of the correction values C(1) through C(8)). In other words, the correction value Ca(4) is a value corresponding to the interval between line L1 formed in pass 1 and line L9 formed in pass 9 after one inch of transport has been performed after the forming of line L1.

It should be noted in regard to the correction values Ca(1) through Ca(3) that since there is no C(i−3) value in the expression for calculating the correction values Ca, the same value as Ca (4) can be used. Also, similarly, in regard to the correction values Ca(34), Ca(35), Ca(36), and Ca(37), since any of C(i+1), C(i+2), C(i+3), and C(i+4) does not exist in the expression for calculating the correction values Ca, the same value as Ca(33) can be used.

The computer 110 calculates the correction values Ca(1) through Ca(37) in this manner. Thereby, the correction values for correcting the DC component transportation error are obtained for each ⅛ inch range.

As mentioned above, the correction values C(1) through C(37) are to be averaged, but the correction values Cb1 and Cb2 are not to be averaged. The section below describes a reason the correction values Cb1 and Cb2 are not to be averaged.

The correction value Cb1 is a correction value for correcting coming-off-roller transportation error. The coming-off-roller transportation error is, as mentioned above, a transportation error that is greatly generated in an instant. For this reason, the correction value Cb1 is large compared to the correction values C(1) through C(37), which are for correcting the DC component transportation error. Therefore, supposing the correction value Cb1 is averaged, there is a risk that coming-off-roller transportation error cannot properly be corrected because the averaged correction value is quite different from the correction value Cb1 before averaging. Accordingly, the correction value Cb1 is not to be averaged. Similarly, the correction value Cb2 is not to be averaged because the correction value Cb2 is not appropriate to be averaged together with other correction values.

Incidentally, description was given above regarding the correction values Ca(i) of the transport operation between pass and pass i+1 (i=1 through 37) (which were derived by averaging), the correction value Cb1 of the transport operation between pass n−1 and pass n, and the correction value Cb2 of the transport operation between pass n and pass n+1; but, no reference was made to a correction value of the transport operation between pass 38 (pass i+1 when i=37) and pass n−1. Here, theses correction values are described.

The same value as Ca(37) is used for the correction value of the transport operation between pass 38 and pass n−1 (this correction value is referred to as a correction value Cc). However, since the theoretical interval between line 37 and line 38 (which is ⅛ inch as described earlier) and the theoretical interval between line 38 and line La1 (which is p inches) are different, the correction value Cc is calculated in consideration of this using the following expression.

Cc=Ca(37)×(p/(⅛))

### Storing Correction Value (SiO₄)

Next, the computer 110 stores the correction values in the memory 63 of the printer 1 (S104).

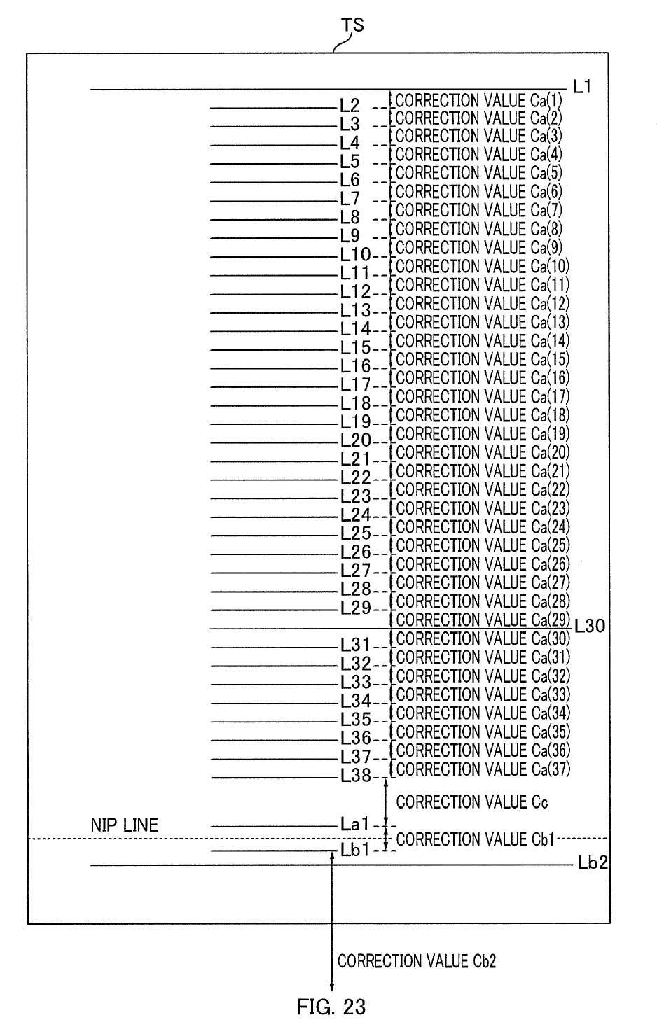

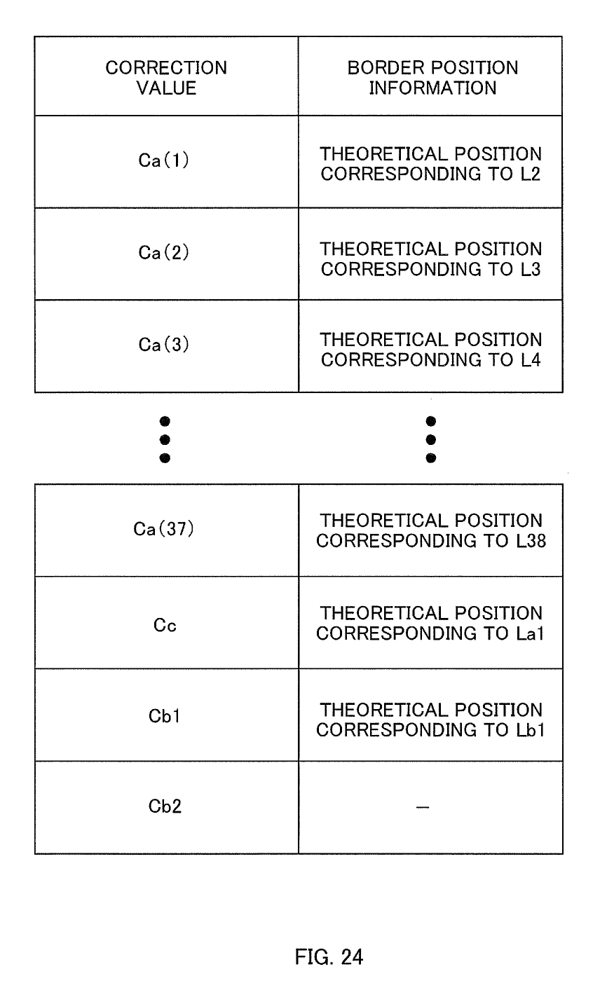

FIG. 23 is an explanatory diagram of ranges associated with the correction values Ca(i), Cc, Cb1, and Cb2. FIG. 24 is an explanatory diagram of a table stored in the memory 63.

In this embodiment, the correction values stored in the memory 63 are the correction values Ca(1) through Ca(37) in the NIP state, the correction value Cc, the correction value Cb1 in the transition from the NIP state and the non-NIP state, and the correction value Cb2 in the non-NIP state. Further, border position information for indicating the range to which each correction value is applied is also associated with each correction value and stored in the memory 63.

In this embodiment, border position information associated with the correction values Ca(i) is information that indicates a position (theoretical position) corresponding to lines L(i+1) in the measurement pattern; this border position information indicates a lower end side border of the range to which the correction values Ca(i) are applied. Note that an upper end side border can be obtained from border position information associated with the correction values Ca(i−1). Accordingly, the applicable range of the correction value Ca(4) for example is a range between the position of line L4 and the position of line L5 with respect to the paper S (at which the nozzle #90 is positioned).

Similarly, in this embodiment, border position information associated with the correction value Cc is information that indicates a position (theoretical position) corresponding to line La1 in the measurement pattern; this border position information indicates a lower end side border of the range to which the correction value Cc is applied. Note that an upper end side border can be obtained from border position information associated with the correction value Ca(37). Accordingly, the applicable range of the correction value Cc is a range between the position of line L38 and the position of line La1 with respect to the paper S (at which the nozzle #90 is positioned).

Furthermore, in this embodiment, border position information associated with the correction value Cb1 is information that indicates a position (theoretical position) corresponding to line Lb1 in the measurement pattern; this border position information indicates a lower end side border of the range to which the correction value Cb1 is applied. Note that an upper end side border can be obtained from the border position information associated with the correction value Cc. Accordingly, the applicable range of the correction value Cb1 is a range between the position of line La1 and the position of line Lb1 with respect to the paper S (at which the nozzle #90 is positioned).

It should be noted that in the case where the nozzle #90 is positioned on the lower end side from line Lb1, it is not necessary to associate border position information (lower end side border) to the correction value Cb2 since the correction value Cb2 is always applied.

At the printer manufacturing factory, a table reflecting the individual characteristics of each individual printer is stored in the memory 63 for each printer that is manufactured. Then, the printer in which this table has been stored is packaged and shipped.

### Transport Operation During Printing by Users

When printing is carried out by a user who has purchased the printer, the controller 60 reads out the table from the memory 63, and corrects the target transport amounts based on the correction values, then carries out the transport operation based on the corrected target transport amounts. A manner of transport operation during printing by the user is described below.

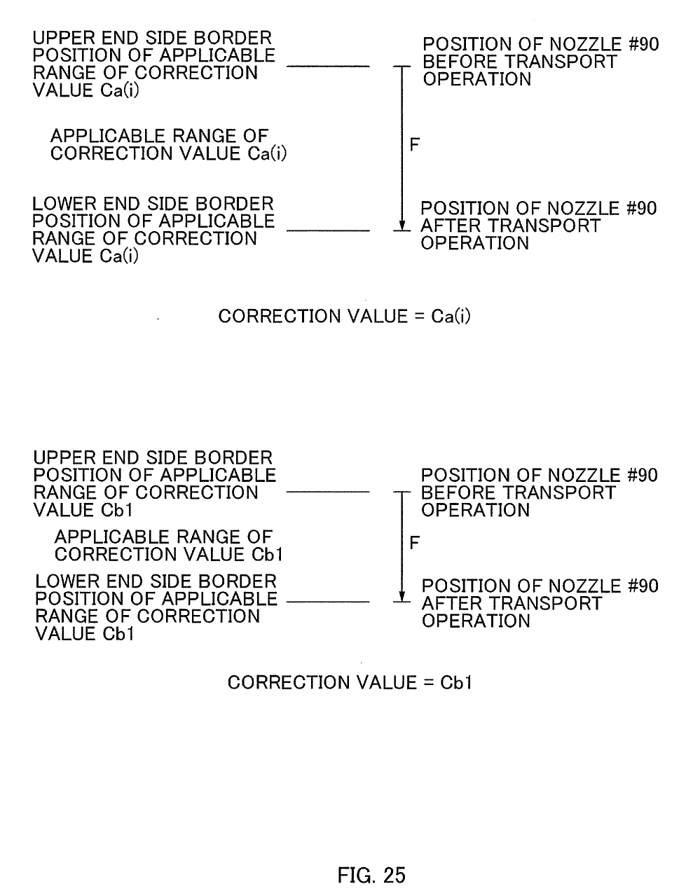

FIG. 25 is an explanatory diagram of correction values in a first case. As shown in the upper portion of FIG. 25, in the first case, the position of the nozzle #90 before the transport operation (relative position with respect to the paper) agrees with the upper end side border position of the applicable range of the correction values Ca(i), and the position of the nozzle #90 after the transport operation agrees with the lower end side border position of the applicable range of the correction values Ca(i). In this case, the controller 60 sets the correction values to Ca (i), sets as a target a value obtained by adding the correction value Ca(i) to an initial target transport amount F, then drives the transport motor 22 to transport the paper.

Also, a same approach can be applied to the correction values Cb1, Cb2, and Cc. For example, as shown in the lower portion of FIG. 25, in the case where the position of the nozzle #90 before the transport operation (relative position with respect to the paper) agrees with the upper end side border position of the applicable range of the correction value Cb1, and the position of the nozzle #90 after the transport operation agrees with the lower end side border position of the applicable range of the correction value Cb1, the controller 60 sets the correction value to Cb1, sets as a target a value obtained by adding the correction value Cb1 to an initial target transport amount F, then drives the transport motor 22 to transport the paper.

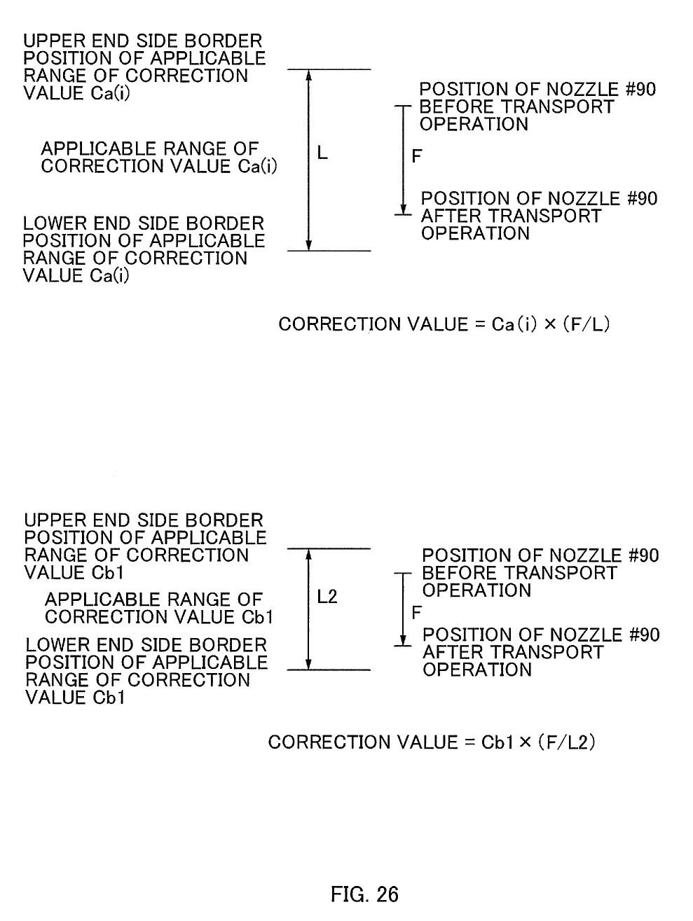

FIG. 26 is an explanatory diagram of correction values in a second case. As shown in the upper portion of FIG. 26, in the second case, the positions of the nozzle #90 before and after the transport operation are both within the applicable range of the correction value Ca(i). In this case, the controller 60 sets as a correction value a value obtained by multiplying a ratio F/L of the initial target transport amount F to the transport direction length L of the applicable range by Ca(i). Then, the controller 60 sets as a target a value obtained by adding the correction value Ca(i)×(F/L) to an initial target transport amount F, then drives the transport motor 22 to transport the paper.

Also, a same approach can be applied to the correction values Cb1, Cb2, and Cc. For example, as shown in the lower portion of FIG. 26, in the case where the positions of the nozzle #90 before and after the transport operation are both within the applicable range of the correction value Cb1, the controller 60 sets the correction value to Cb1×(F/L2), sets as a target a value obtained by adding the correction value Cb1×(F/L2) to an initial target transport amount F, then drives the transport motor 22 to transport the paper.

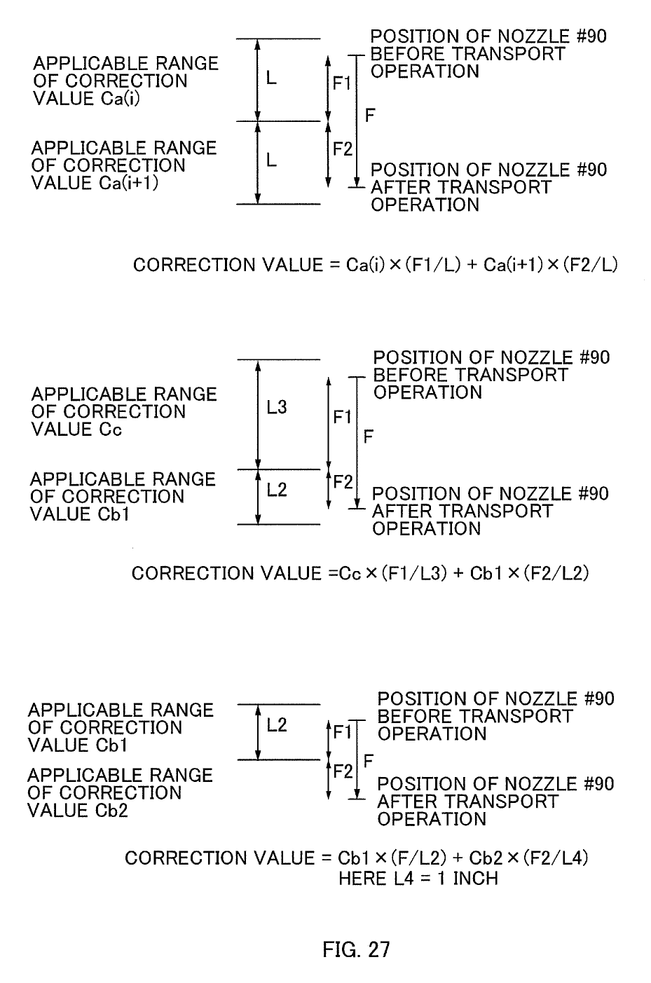

FIG. 27 is an explanatory diagram of correction values in a third case. As shown in the upper portion of FIG. 27, in the third case, the position of the nozzle #90 before the transport operation is within the applicable range of the correction values Ca(i), and the position of the nozzle #90 after the transport operation is within the applicable range of the correction values Ca(i+1). Here, of the target transport amount F, the transport amount in the applicable range of the correction values Ca(i) is set as F1, and the transport amount in the applicable range of the correction values Ca(i+1) is set as F2. In this case, the controller 60 sets as the correction value a sum of a value obtained by multiplying Ca(i) by F1/L and a value obtained by multiplying Ca(i+1) by F2/L. Then, the controller 60 sets as a target a value obtained by adding the correction value Ca(i)×(F1/L)+Ca(i+1)×(F2/L) to the initial target transport amount F, then drives the transport motor 22 to transport the paper.

Also, a same approach can be applied to the correction values Cb1, Cb2, and Cc. For example, as shown in the middle portion of FIG. 27, in the case where the position of the nozzle #90 before the transport operation is within the applicable range of the correction value Cc, and the position of the nozzle #90 after the transport operation is within the applicable range of the correction value Cb1, the controller 60 sets the correction values to Cc×(F1/L3)+Cb1×(F2/L2), sets as a target a value obtained by adding the correction value Cc×(F1/L3)+Cb1×(F2/L2) to an initial target transport amount F, then drives the transport motor 22 to transport the paper.

Furthermore, as shown in the lower portion of FIG. 27, in the case where the position of the nozzle #90 before the transport operation is within the applicable range of the correction value Cb1, and the position of the nozzle #90 after the transport operation is within the applicable range of the correction value Cb2, the controller 60 sets the correction values to Cb1×(F1/L2)+Cb2×(F2/L4), sets as a target a value obtained by adding the correction value Cb1×(F1/L2)+Cb2×(F2/L4) to an initial target transport amount F, then drives the transport motor 22 to transport the paper. Note that L4 is set to a theoretical transport amount for a transport operation carried out between pass n and pass n+1, namely, one inch.

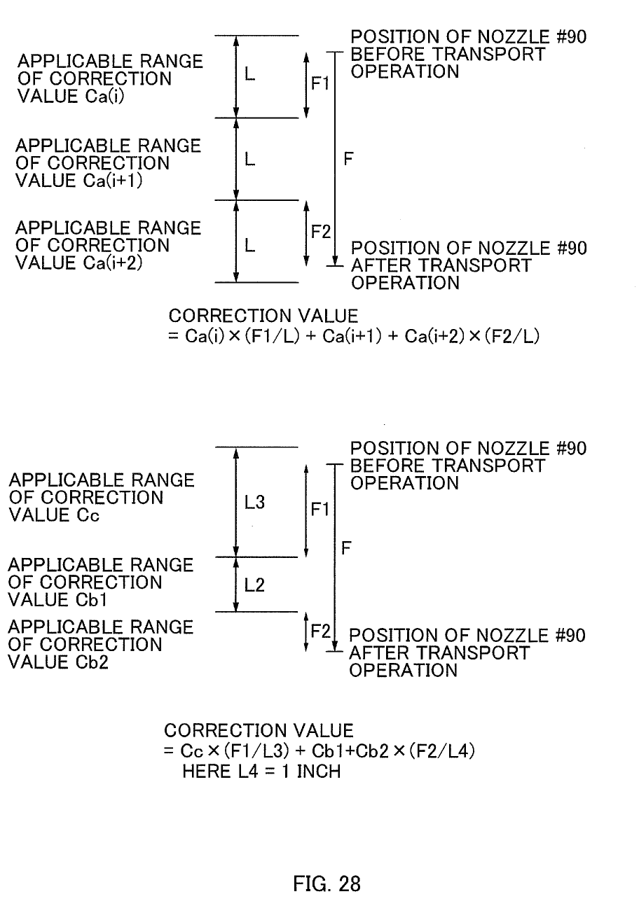

FIG. 28 is an explanatory diagram of correction values in a fourth case. As shown in the upper portion of FIG. 28, in the fourth case, the paper is transported so as to pass the applicable range of the correction values Ca(i+1). In this case, the controller 60 sets as the correction value a sum of a value obtained by multiplying Ca(i) by F1/L, Ca(i+1), and a value obtained by multiplying Ca(i+2) by F2/L. Then, the controller 60 sets as a target a value obtained by adding the correction value Ca(i)×(F1/L)+Ca(i+1)+Ca(i+2)×(F2/L) to an initial target transport amount F, then drives the transport motor 22 to transport the paper.

Also, a same approach can be applied to the correction values Cb1, Cb2, and Cc. For example, as shown in the lower portion of FIG. 28, in the case where the position of the nozzle #90 before the transport operation is within the applicable range of the correction value Cc, and the paper is transported so as to pass the applicable range of the correction value Cb1, the controller 60 sets the correction value to Cc×(F1/L3)+Cb1+Cb2×(F2/L4), sets as a target a value obtained by adding the correction value Cc×(F1/L3)+Cb1+Cb2×(F2/L4) to an initial target transport amount F, then drives the transport motor 22 to transport the paper. Note that L4 is set to a theoretical transport amount for a transport operation carried out between pass n and pass n+1, namely, one inch.

In this manner, when the controller 60 corrects the initial target transport amount F and controls the transportation unit 20 based on the corrected target transport amount, the actual transport amount is corrected so as to become the initial target transport amount F, and the transportation error is corrected.

Regarding Effectiveness of Printer According to this Embodiment

The above-mentioned the printer 1 (a) forms line La1 (first pattern) by causing the head 41 to eject ink onto the test sheet TS when the rear end section of the test sheet TS is sandwiched with the sandwich section of the upstream-side transport rollers 23; (b) causes the upstream-side transport rollers 23 and the downstream-side transport rollers 25 to transport the test sheet TS until the rear end section of the test sheet TS, on which line La1 is formed, becomes positioned closer to the downstream side than the sandwich section in the transport direction and ceases to be sandwiched with the sandwich section; and (c) forms line Lb1 (second pattern) by causing the head 41 to eject ink onto the test sheet TS whose rear end section is not sandwiched with the sandwich section. Therefore, it is possible to sufficiently grasp a transportation error (coming-off-roller transportation error) of the test sheet TS at a moment when the test sheet TS ceases to be sandwiched with the sandwich section of the upstream-side transport rollers 23. This is described below.

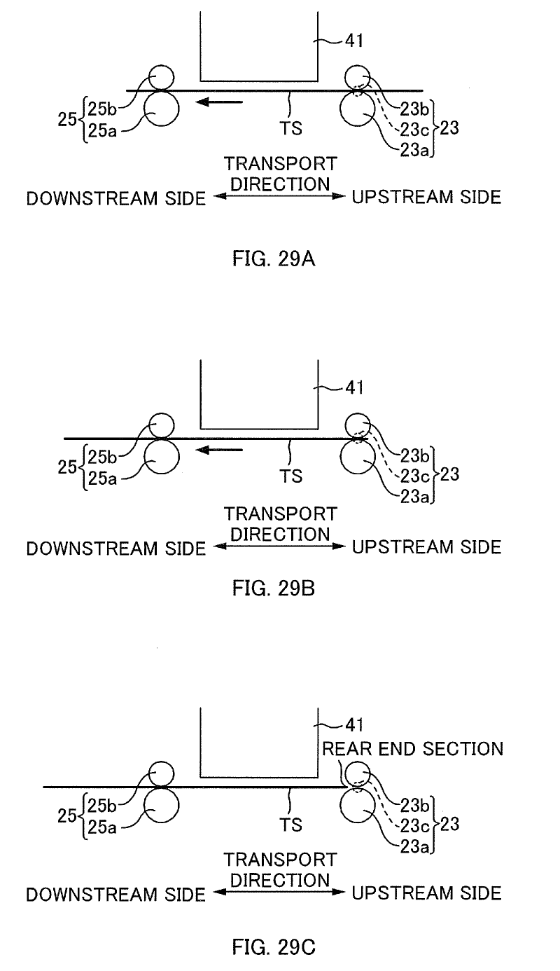

As mentioned above, the upstream-side transport rollers 23 and the downstream-side transport rollers 25 transport the test sheet TS in cooperation with each other by rotating with the test sheet TS being sandwiched therebetween (FIG. 29A). However, after the rear end section of the test sheet TS pass the sandwich section of the upstream-side transport rollers 23 (a portion indicated with reference symbol 23c of FIG. 29A), only the downstream-side transport rollers 25 transport the test sheet TS (FIGS. 29B and 29C). It is known that there is difference between transporting manner of the test sheet TS when the test sheet TS is transported with being sandwiched with two sets of the transport rollers, and transporting manner of the test sheet TS at a moment when the test sheet TS ceases to be sandwiched with the sandwich section 23c of the upstream-side transport rollers 23. That is, the transport amount at a moment when the test sheet TS ceases to be sandwiched with the sandwich section 23c temporarily decreases or increases compared to the transport amount when the test sheet TS is transported with being sandwiched with two sets of the transport rollers. FIGS. 29A through 29C are diagrams for illustrating transport conditions of the test sheet TS.

Regarding transportation error when the test sheet TS is transported with being sandwiched with the sandwich section 23c of the upstream-side transport rollers 23, correction values for the transportation error are obtained conventionally by forming a pattern on the test sheet TS. On the other hand, regarding transportation error of the test sheet TS when the test sheet TS ceases to be sandwiched with the sandwich section 23c, a pattern for correcting the transportation error is not formed conventionally; as a result thereof, the transportation error is not corrected properly.

In contrast, in formation of the measurement pattern according to this embodiment, line La1 (first pattern) is formed (FIG. 29B) when the rear end section of the test sheet TS is sandwiched with the sandwich section 23c of the upstream-side transport rollers 23; thereafter, line La2 (second pattern) is formed (FIG. 29C) on the test sheet TS that has been transported until the rear end section ceases to be sandwiched with the sandwich section 23c. In such a case, a transport of the test sheet TS between formations of line La1 and line La2 is a transport of a transport amount that reflects particularly coming-off-roller transportation error (further, in this embodiment, a transport amount between formations of line La1 and line La2 is set small in such a manner as the sudden change of the test sheet TS when its end comes off the rollers is reflected greatly). For this reason, the coming-off-roller transportation error can be obtained by obtaining the interval between line La1 and line La2, for example. That is, it is possible to sufficiently grasp the coming-off-roller transportation error based on line La1 and line La2.

Further, line La1 and line La2 are a pattern for correcting the transportation error (coming-off-roller transportation error) of the test sheet TS produced when the test sheet TS whose rear end section is sandwiched with the sandwich section 23c is transported in such a manner as the rear end section is positioned closer to the downstream side than the sandwich section 23c in the transport direction. In such a case, coming-off-roller transportation error is sufficiently grasped based on line La1 and line La2. Therefore, it is possible to properly correct the coming-off-roller transportation error by obtaining the correction value Cb1 based on the interval between line La1 and line La2, for example.

Furthermore, the first pattern and the second pattern are each a line formed in a direction intersecting the transport direction of the test sheet TS. In such a case, it is possible to promptly form the patterns by forming the first pattern (line La1) and the second pattern (line La2) in respective one pass (that is, forming line La1 in pass n−1 and line La2 in pass n).

Furthermore, the transport amount of the test sheet TS (specifically, ⅙ inch) from formation of line La1 to formation of line La2 is less than the transport amount of the test sheet TS (1 inch) when the upstream-side transport rollers 23 (the paper carry roller 23a) perform one rotation. As mentioned above, the coming-off-roller transportation error is generated in an instant (within a period shorter than a period in which the paper carry roller 23a performs one rotation). For this reason, by shortening the interval between line La1 and line La2 (⅙ inch) for correcting the transportation error (in other words, decreasing the transport amount of the test sheet TS), the correction value Cb1 that has been calculated based on line La1 and line La2 reflects the transportation error; so that correction can be performed more properly.

Transportation Error when Contacting Roller and Pattern Printing for Correcting it

### Roller-Contact Transportation Error of Front End of Paper S

In the foregoing description, as transportation error, description was given about the DC component transportation error, the AC component transportation error, and coming-off-roller transportation error; in addition to these transportation errors, there is roller-contact transportation error of the front end of the paper S. The roller-contact transportation error is a transportation error generated at a moment when the front end of the paper S becomes in contact with the downstream-side transport rollers 25.

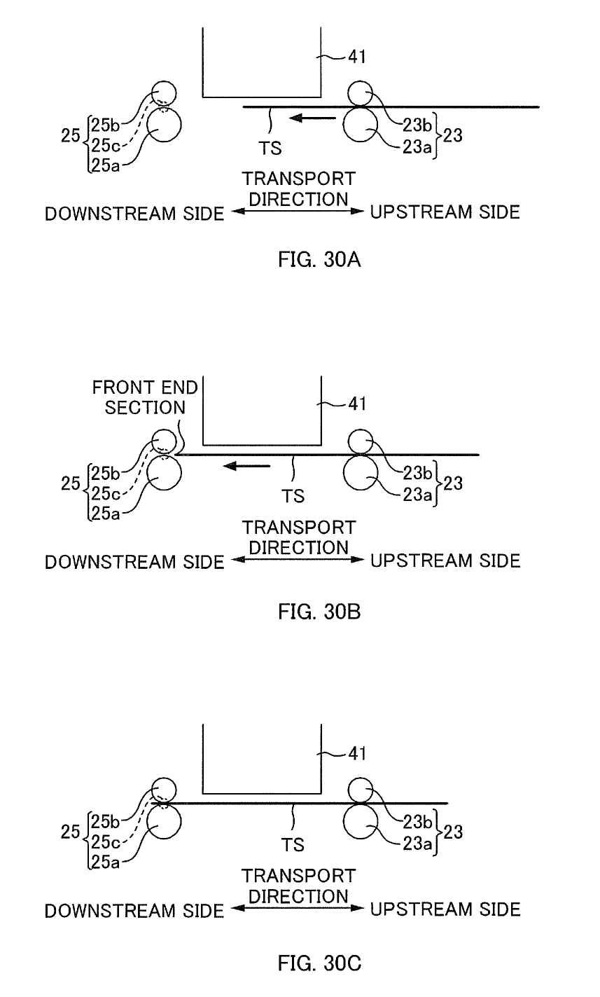

FIGS. 30A through 30C are diagrams for illustrating the roller-contact transportation error of the front end of the paper S. As shown in FIGS. 30A and 30B, when the paper S remains sandwiched between the upstream-side transport rollers 23 and is transported in the transport direction, the front end of the paper S (end of the paper S on the downstream side in the transport direction) becomes sandwiched between the downstream-side transport rollers 25 as shown in FIG. 30C. That is, the paper S is sandwiched between the upstream-side transport rollers 23 and between the downstream-side transport rollers 25. Thereafter, in cooperation with these sets of the rollers, the paper S is further transported toward the downstream side.

When the paper S remains sandwiched between only the upstream-side transport rollers 23 and is transported, an attitude of the paper S is stable and a transport amount is also stable. However, when the paper S starts to be sandwiched between the downstream-side transport rollers 25, the attitude of the paper S suddenly changes. For example, when the paper S starts to be sandwiched between the downstream-side transport rollers 25, the paper S is pulled by the downstream-side transport rollers 25. This makes the transport amount change suddenly, which produces transportation error. Note that the roller-contact transportation error is generated in an instant similar to the coming-off-roller transportation error.

### Pattern Printing for Correcting

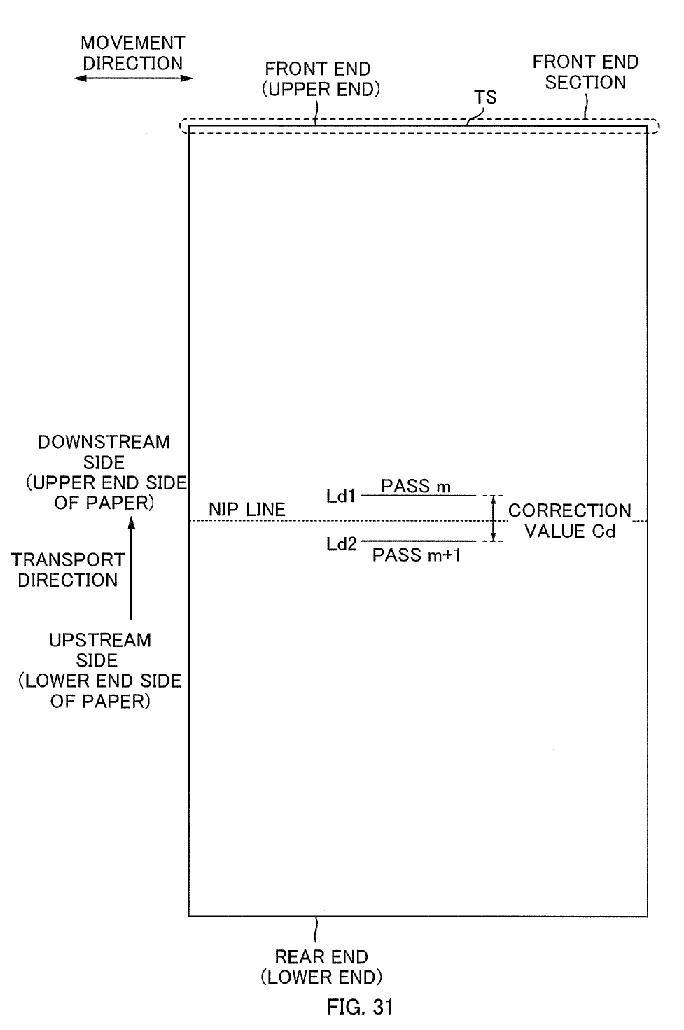

In order to correct the roller-contact transportation error, a correction value Cd for correcting this transportation error is also prepared, similar to the above-mentioned correction values Ca(i), Cb1, and Cb2. In order to obtain the correction value Cd, line Ld1 and line Ld2 are formed on the test sheet TS as shown in FIG. 31. Note that FIG. 31 is a diagram showing the test sheet on which the measurement pattern is printed.

Here, line Ld1 and line Ld2 are described. Line Ld1 and line Ld2 are formed in a direction intersecting the transport direction (the movement direction). In FIG. 31, a position on the test sheet TS opposing the most upstream the nozzle #90 when the front end of the test sheet TS passes a sandwich section of the downstream-side transport rollers 25 is indicated as “the NIP line” with the dotted line. Line Ld1 is a line formed on the downstream side from the NIP line, and line Ld2 is a line formed on the upstream side from the NIP line. In this embodiment, line Ld1 corresponds to the first pattern, and line Ld2 corresponds to the second pattern.

Next, a method for forming line Ld1 and line Ld2 is described.

Line Ld1 is formed by ejecting ink from the nozzle #90 in a certain pass m when a front end section of the test sheet TS (an end section on the downstream side in the transport direction) is positioned closer to the upstream side in the transport direction than the sandwich section of the downstream-side transport rollers 25 (a portion indicated with reference symbol 25c of FIG. 30A) and is not sandwiched with the sandwich section 25c. The front end section includes the front end of the test sheet TS and its periphery.

After pass m, the paper carry roller 23a is caused to perform a ⅙ rotation (since transition from the non-NIP state to the NIP state is carried out during this rotation, paper becomes transported with the upstream-side transport rollers 23 and the downstream-side transport rollers 25 at this stage). Thereby, the test sheet TS is transport by approximately ⅙ inch. Then, after the front end of the test sheet TS has passed the downstream-side transport rollers 25, ink is ejected from only the nozzle #90 in pass m+1, and thereby line Ld2 is formed onto the test sheet TS whose front end section is sandwiched with the sandwich section 25c of the downstream-side transport rollers 25.

As mentioned above, in this embodiment, the printer (a) forms line Ld1 when the front end section of the test sheet TS is positioned closer to the upstream side in the transport direction than the sandwich section 25c of the downstream-side transport rollers 25 and is not sandwiched with the sandwich section 25c (FIG. 30B); (b) causes the test sheet TS to be transported until the front end section starts to be sandwiched with the sandwich section 25c; and (c) forms line Ld2 onto the test sheet TS whose front end section is sandwiched with the sandwich section 25c (FIG. 30C). In such a case, a transport of the test sheet TS carried out between formation of line Ld1 and line Ld2 is a transport having a transport amount that particularly reflects roller-contact transportation error (further, in this embodiment, a transport amount between formation of line Ld1 and line Ld2 is set small in such a manner as the sudden change of the test sheet TS when its end becomes in contact with the rollers is reflected greatly). For this reason, the roller-contact transportation error can be obtained by obtaining the interval between line Ld1 and line Ld2. That is, it is possible to sufficiently grasp the roller-contact transportation error based on line Ld1 and line Ld2.

The correction value Cd for correcting the roller-contact transportation error is obtained based on line Ld1 and line Ld2 formed as mentioned above. A method for calculating the correction value Cd is the same as the above-mentioned method for calculating the correction value Cb1 (FIG. 13). For this reason, correcting the transport amount based on the correction value Cd allows the roller-contact transportation error to be properly corrected.

In the foregoing description, only line Ld1 and line Ld2 are formed on the test sheet TS; but line Ld1 and line Ld2 may be formed together with a plurality of lines shown in FIG. 9. In such a case, printing one test sheet allows all of above-mentioned correction values to be calculated.

### Other Embodiments

In the above-mentioned embodiment, the printer is mainly described. However, as a matter of course, the description also includes disclosures of a printing apparatus, a recording apparatus, a liquid ejection apparatus, a transporting method, a printing method, a recording method, a liquid ejection method, a printing system, a recording system, a computer system, a program, a storage media having a program stored thereon, a display screen, a screen display method, a method for producing printed material, and the like.

Further, a printer and the like is described as one embodiment. However, the above-mentioned embodiment is provided for facilitating the understanding of the invention, and not for limiting the invention. As a matter of course, the invention can be altered and improved without departing from the gist thereof and the invention includes equivalents thereof. Particularly, embodiments described below are also included in the invention.

In the above-mentioned embodiment, the printer is described, but the invention is not limited thereto. For example, technology like that of this embodiment can also be adopted for various types of liquid ejection apparatuses that use inkjet technology, including color filter manufacturing devices, dyeing devices, fine processing devices, semiconductor manufacturing devices, surface processing devices, three-dimensional shape forming machines, liquid vaporizing devices, organic EL manufacturing devices (particularly macromolecular EL manufacturing devices), display manufacturing devices, film formation devices, and DNA chip manufacturing devices.

Furthermore, there is no limitation to the use of piezo elements, and for example, application in thermal printers or the like is also possible.

Furthermore, in the above-mentioned embodiment, the first pattern and the second pattern are a pattern for correcting the coming-off-roller transportation error or the roller-contact transportation error. However, the invention is not limited thereto. For example, the first pattern and the second pattern may be a pattern for confirming whether a correction value for these transportation errors is a proper value or not.

Furthermore, in the above-mentioned embodiment, a medium is sandwiched between a pair of rollers. However, the invention is not limited thereto. For example, a medium may be sandwiched between a roller and a member that is not a roller.

What is claimed is:

1. A liquid ejection apparatus, comprising:
(a) an ejecting section that ejects liquid onto a medium;
(b) an upstream-side transport roller that is positioned closer to an upstream side than the ejecting section in a transport direction of the medium, and a downstream-side transport roller that is positioned closer to a downstream side than the ejecting section,
the upstream-side transport roller and the downstream-side transport roller transporting the medium in cooperation with each other by rotating; and
(c) a control section
that forms a first pattern by causing the ejecting section to eject the liquid onto the medium in case that an upstream-side end section of the medium in the transport direction is sandwiched with a sandwich section of the upstream-side transport roller,
that causes the upstream-side transport roller and the downstream-side transport roller to transport the medium until the upstream-side end section of the medium on which the first pattern is formed becomes positioned closer to the downstream side than the sandwich section in the transport direction and ceases to be sandwiched with the sandwich section, and
that forms a second pattern by causing the ejecting section to eject the liquid onto the medium the upstream-side end section of which is not sandwiched with the sandwich section.

2. A liquid ejection apparatus according to claim 1, wherein
the first pattern and the second pattern are a pattern for correcting a transportation error of the medium in case that
the medium the upstream-side end section of which is sandwiched with the sandwich section is transported in such a manner as the upstream-side end section is positioned closer to the downstream side than the sandwich section in the transport direction.

3. A liquid ejection apparatus according to claim 1, wherein
the first pattern and the second pattern are each a line formed in a direction intersecting the transport direction.

4. A liquid ejection apparatus according to claim 1, wherein
a transport amount of the medium from formation of the first pattern to formation of the second pattern is less than a transport amount of the medium in case that the upstream-side transport roller performs one rotation.

5. A liquid ejection apparatus, comprising:
(a) an ejecting section that ejects liquid onto a medium;
(b) an upstream-side transport roller that is positioned closer to an upstream side than the ejecting section in a transport direction of the medium, and a downstream-side transport roller that is positioned closer to a downstream side than the ejecting section,
the upstream-side transport roller and the downstream-side transport roller transporting the medium in cooperation with each other by rotating; and
(c) a control section
that forms a first pattern by causing the ejecting section to eject the liquid onto the medium in case that a downstream-side end section of the medium in the transport direction is positioned closer to an upstream side in the transport direction than a sandwich section of the downstream-side transport roller and is not sandwiched with the sandwich section,
that causes the upstream-side transport roller and the downstream-side transport roller to transport the medium until the downstream-side end section of the medium on which the first pattern is formed starts to be sandwiched with the sandwich section, and
that forms a second pattern by causing the ejecting section to eject the liquid onto the medium the downstream-side end section of which is sandwiched with the sandwich section.

6. A method for forming a pattern, comprising:
forming a first pattern onto a medium that is transported by an upstream-side transport roller and by a downstream-side transport roller in case that a upstream-side end section of the medium in a transport direction is sandwiched with a sandwich section of the upstream-side transport roller;
causing the upstream-side transport roller and the downstream-side transport roller to transport the medium until the upstream-side end section of the medium on which the first pattern is formed becomes positioned closer to the downstream side than the sandwich section in the transport direction and ceases to be sandwiched with the sandwich section; and
forming a second pattern onto the medium the upstream-side end section of which is not sandwiched with the sandwich section.
